(19) United States
(12) Patent Application Publication
(10) Pub. No.: US 2026/0272742 A1
(43) Pub. Date: Sep. 17, 2026

(54) RESTRAINT SYSTEM FOR PATIENT SUPPORT APPARATUS

(71) Applicant: Stryker Corporation, Portage, MI (US)

(72) Inventors: Christopher Ryan Sweeney, Portage, MI (US); Anish Paul, Portage, MI (US)

(21) Appl. No.: 19/162,469

(22) PCT Filed: Mar. 4, 2024
(86) PCT No.: PCT/US2024/018335

§ 371 Date: Sep. 5, 2025

Related U.S. Application Data
(60) Provisional application No. 63/450,814, filed on Mar. 8, 2023.

(51) Int. Cl. A61G 7/018; A61G 7/015; A61G 7/057

(52) U.S. Cl. CPC A61G 7/018; A61G 7/015; A61G 7/05776

(57) ABSTRACT

A patient support may include a deck and a mattress supportable on the deck. The mattress may include a head end, a foot end, and two opposed sides, and the mattress may include an electrical system configured to at least one of 1) receive power from a power source and 2) include a communication interface for communicating data between the mattress and another device. The patient support may include a support side coupler operably to facilitate restraining the mattress from moving in at least one direction relative to the deck.

### TECHNICAL FIELD

The present disclosure relates to a patient support apparatus, and more particularly toward a restraint for coupling a mattress to a patient support apparatus.

### BACKGROUND

The present disclosure relates to patient support apparatuses, such as beds, cots, stretchers, recliners, or the like. More specifically, the present disclosure relates to patient support apparatuses that include a removable or serviceable mattress or other type of patient support.

Conventional patient support apparatuses often include a patient support, such as a mattress, disposed on a deck of the patient support apparatus. The patient support may be removable or serviceable to allow a caregiver or technician to replace or maintain the patient support. In one conventional application, the patient support may include an electrical system, such as a pump controller and pump, that uses power from an external source instead of an internal power source. The patient support apparatus may include a main electrical system separate from the electrical system of the patient support, which may be considered a secondary electrical system in such a configuration. The main electrical system may include a control system configured to direct operation of the pump controller and consequently the pump. Such directives from the main electrical system to the secondary electrical system may be provided via a communication link therebetween.

The electrical system of the patient support (e.g., the electrical system described previously) receives power and establishes communications with other components (e.g., the main electrical system) via an electrical wiring harness connectable to the patient support. In many cases, the electrical wiring harness and the connections thereof are susceptible to breakage or failed connections due to movement and usage of the patient support apparatus. For instance, raising the Fowler of the patient support apparatus may cause a change in position of the patient support on the deck of the patient support apparatus, thereby straining the electrical wireless or connections thereof.

### SUMMARY

In general, one innovative aspect of the subject matter described herein can be provided in a patient support for a patient. The patient support may include a deck and a mattress supportable on the deck. The mattress may include a head end, a foot end, and two opposed sides, and the mattress may include an electrical system configured to at least one of 1) receive power from a power source and 2) include a communication interface for communicating data between the mattress and another device. The patient support may include a support side coupler operably to facilitate restraining the mattress from moving in at least one direction relative to the deck.

The support side coupler may include a first support side electrical contact, and the mattress may include a mattress side coupler configured to mechanically couple to the support side coupler to couple the mattress to the support side coupler and facilitate restraining the mattress relative to the deck.

The patient support apparatus may include a mattress side coupler connected to or part of the mattress. The mattress side coupler may include a first mattress side electrical contact configured to electrically connect to the first support side electrical contact of the support side coupler.

In one aspect, the mattress side coupler may include a second mattress side electrical contact configured to electrically connect to a second support side electrical contact of the support side coupler.

The foregoing and other aspects can each optionally include one or more of the following features, alone or in combination. In particular, one configuration includes all the following features in combination.

In some aspects, the first support side electrical contact may be electrically coupled to a power source and operable to supply power to the electrical system of the mattress via a connection with the first mattress side electrical contact.

In some aspects, the second support side electrical contact may be coupled to the other device and operable to transfer communication between the other device and the electrical system via a connection with the second mattress side electrical contact.

In some aspects, the support side coupler may include a support side ground contact that is electrically coupled to a ground of the power source. The mattress side coupler may include a mattress side ground contact configured to electrically connect to the support side ground contact.

In some aspects, the communication interface may be configured to at least one of receive and transmit a discrete signal from the other device via the second support side contact and the second mattress side contact.

In some aspects, the communication interface may be configured to at least one of receive and transmit a serial communication signal from the other device via the second support side contact and the second mattress side contact.

In some aspects, the first and second mattress side contacts may be spring loaded contacts.

In some aspects, the first and second mattress side contacts may be biased into contact with the first and second support side contacts under the force of gravity exerted on the mattress.

In some aspects, the support side coupler may include a recess operable to receive an engagement body of the mattress side coupler and to restrain the mattress side coupler from moving laterally and vertically with respect to the deck.

In some aspects, the engagement body of the mattress side coupler may include the first and second mattress side contacts, where the first and second mattress side contacts of the engagement body may be operable to engage the first and second support side contacts in the recess.

In some aspects, the support side coupler and the mattress side coupler may provide a slide locking mechanism to restrain the mattress with respect to the deck in at least one direction.

In some aspects, the patient support apparatus includes a latching mechanism mounted to aide in maintaining a coupling between the mattress side coupler and the support side coupler.

In some aspects, the latching mechanism may include a release and a catch that is operable to decouple the mattress side coupler from the deck side coupler.

In some aspects, the mattress side coupler may be connected to the mattress via a strap.

In some aspects, the strap may include electrical conductors connected to the first and second mattress side electrical contacts.

In some aspects, the mattress may include a patient support surface formed by a plurality of inflatable bladders (potentially, extending from the head end to the foot end). The mattress may include a recessed portion beneath the patient support surface (potentially, at the foot end of the mattress). An enclosure may be housed in the recessed portion and includes the electrical system. The electrical system may include a pump for directing air to the plurality of inflatable bladders and a controller for operating the pump.

In general, one innovative aspect of the subject matter described herein can be provided in a mattress for a patient support. The patient support may include a deck and a support side coupler operable to facilitate restraining the mattress from moving in at least one direction relative to the deck. The support side coupler may include a first support side electrical contacts. The mattress may include a head end, a foot end, two opposed sides.

The mattress may include an electrical system may be at least one of 1) configured to receive power from a power source and 2) include a communication interface for communicating data between the mattress and another device.

The mattress may include a mattress side coupler configured to mechanically couple to the support side coupler to couple the mattress to the support side coupler and facilitate restraining the mattress relative to the deck. The mattress side coupler may include a first mattress side electrical contact configured to electrically connect to the first support side electrical contact of the support side coupler.

In one aspect, the mattress side coupler may include a second mattress side electrical contact configured to electrically connect to a second support side electrical contact of the support side coupler.

The foregoing and other configurations can each optionally include one or more of the following features, alone or in combination. In particular, one configuration includes all the following features in combination.

In some aspects, the communication interface may be configured to at least one of receive and transmit a discrete signal from the other device via the first support side electrical contact and the first mattress side electrical contact.

In some aspects, the communication interface may be configured to at least one of receive and transmit a serial communication signal from the other device via the first support side electrical contact and the first mattress side electrical contact.

In some aspects, the first and second mattress side electrical contacts may be spring loaded contacts.

In some aspects, the first and second mattress side electrical contacts may be biased into contact with the first and second support side electrical contacts under the force of gravity exerted on the mattress.

In some aspects, the support side coupler may include a recess operable to receive an engagement body of the mattress side coupler and to restrain the mattress side coupler from moving laterally and vertically with respect to the deck.

In some aspects, the engagement body of the mattress side coupler may include the first and second mattress side electrical contacts, where the first and second mattress side electrical contacts of the engagement body may be operable to engage the first and second support side electrical contacts in the recess.

In some aspects, the support side coupler and the mattress side coupler may provide a slide locking mechanism to restrain the mattress with respect to the deck and at least one direction.

In some aspects, the patient support apparatus includes a latching mechanism mounted to aide in maintaining a coupling between the mattress side coupler and the support side coupler.

In some aspects, the latching mechanism may include a release and a catch that is operable to decouple the mattress side coupler from the deck side coupler.

In some aspects, the mattress side coupler may be connected to the mattress via a strap.

In some aspects, the strap may include electrical conductors connected to the first and second mattress side electrical contacts.

In general, one innovative aspect of the subject matter described herein can be provided in an indicator system for a mattress and a patient support apparatus. The mattress may be operable to couple to the patient support apparatus via a coupling between a mattress side coupler of the mattress and a support side coupler of the patient support apparatus. The indicator system may include a detector operably connected to or part of to one of the mattress or the patient support apparatus, and a target operably connected to or part of the other of the mattress or the patient support apparatus. The target may be configured to be disposed to activate the detector in response to engagement between the mattress side coupler and the support side coupler, where the detector may be operable to provide an indication of the target activating the detector, and where the indication identifies engagement of the coupling between the mattress side coupler and the support side coupler.

The foregoing and other aspects can each optionally include one or more of the following features, alone or in combination. In particular, one configuration includes all the following features in combination.

In some aspects, the target may be configured to be disposed at least one of in proximity to or in contact with the detector.

In some aspects, the target may be part of a deck of the patient support apparatus.

In some aspects, the detector may be configured to generate an electrical signal that is representative of the indication provided to identify engagement of the coupling between the mattress side coupler and the support side coupler.

In some aspects, the electrical signal may be provided to a control system of the patient support apparatus. The control system may be operable to direct a user interface to provide an indication pertaining to disengagement of the coupling between in the mattress side coupler and the support side coupler.

In some aspects, the detector may be a switch including an actuator movable by the target to activate the switch to generate the electrical signal.

In some aspects, the detector may be mounted to a frame of the patient support apparatus. The mattress side coupler may be operable to engage a portion of the frame corresponding to the support side coupler. The mattress side coupler may include the target and positions the target in contact with the detector as the mattress side coupler engages the portion of the frame.

In some aspects, the mattress side coupler may include a hook operable to engage the portion of the frame in response to rotation of the mattress side coupler from an unhooked position to a hooked position.

In some aspects, the mattress side coupler may be connected to the mattress via a strap.

In some aspects, the strap may include electrical conductors connected to the first and second mattress side electrical contacts.

In some aspects, the detector may include a mechanical indicator operable to transition between a first position and a second position in response to activation by the target due to engagement between the mattress side coupler and the support side coupler.

In some aspects, the first position may identify non-engagement of the coupling between the mattress side coupler and the support side coupler, and the second position may provide the indication identifying engagement of the coupling between the mattress side coupler and the support side coupler.

In some aspects, at the first position, the mechanical indicator may show a red identifier, and where, at the second position, the mechanical indicator may show a green identifier indicative of engagement of the coupling between the mattress side coupler and the support side coupler.

In some aspects, the detector may include at least one of a proximity sensor, a pressure sensor, and a photoelectric laser sensor.

In general, one innovative aspect of the subject matter described herein can be provided in a patient support coupler for a patient support. The patient support may include a deck and a mattress supportable on the deck. The mattress may include a head end, a foot end, and two opposed sides, and the deck may include an opening.

In one aspect, the patient support coupler may include a mattress coupler operable to couple the patient support coupler to the mattress.

In one aspect, the patient support coupler may include a latching mechanism configured to releasably engage the patient support to releasably couple the patient support coupler to the patient support. The latching mechanism may include a spring biased catch that releasably engages the patient support. The latching mechanism may include a release operable by a user to disengage the catch from the patient support to facilitate removal of the patient support coupler from the patient support.

The foregoing and other aspects can each optionally include one or more of the following features, alone or in combination. In particular, one configuration includes all the following features in combination.

In one aspect, the patient support coupler may include an engagement body operable to engage the patient support to facilitate coupling the patient support coupler to the patient support.

In one aspect, the latching mechanism may be configured to releasably engage the patient support to releasably couple the patient support coupler to the patient support in cooperation with the engagement body.

In one aspect, the engagement body may be operable to engage an edge of the deck.

In one aspect, the engagement body may be receivable by the opening of the deck, and the edge may define at least a portion of the opening.

In one aspect, the edge may correspond to a perimeter edge of the deck.

In one aspect, the engagement body may include electrical contacts configured to electrically connect with support-side electrical contacts of the patient support for transmission of power and/or data to the engagement body.

In one aspect, the spring biased catch may be operable to engage an edge of the opening of the deck to facilitate engagement between the patient support coupler and the deck.

In one aspect, the mattress coupler may include a strap.

Before the embodiments and aspects of the disclosure are explained in detail, it is to be understood that the disclosure is not limited to the details of operation or to the details of construction and the arrangement of the components set forth in the following description or illustrated in the drawings. The disclosure may be implemented in various other embodiments and aspects and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments and aspects. Unless otherwise expressly stated, the use of enumeration should not be construed as limiting one or more embodiments or aspects to any specific order or number of components. Nor should the use of enumeration be construed as excluding from the scope of an embodiment or aspect any additional steps or components that might be combined with or into the enumerated steps or components.

### BRIEF DESCRIPTION OF THE DRAWINGS

FIG. 1 shows a perspective view of a patient support apparatus.

FIG. 2 shows a side view of the patient support apparatus.

FIG. 3 shows a top, representative view of a coupling of a retainment system according to one aspect of the present disclosure.

FIG. 4 shows a partial sectional view of FIG. 3.

FIG. 5 shows a partial sectional view of FIG. 3.

FIG. 6 shows a perspective view of a retainment system.

FIG. 7 shows another perspective view of FIG. 6 with the Fowler shown transparent.

FIG. 8 shows another perspective view of the retainment system of FIG. 6.

FIG. 9 shows perspective view of a mattress side coupler according to one aspect of the present disclosure.

FIG. 10 shows another perspective view of the mattress site coupler in FIG. 9.

FIG. 11 shows a perspective view of a deck side coupler according to one aspect of the present disclosure.

FIG. 12 shows a sectional view of a retainment system according to one aspect of the present disclosure.

FIG. 13 shows a perspective view of a retainment system according to one aspect of the present disclosure.

FIG. 14 shows another perspective view of FIG. 13 with the Fowler shown transparent.

FIG. 15 shows a top, partial view of the retainment system in FIG. 13.

FIG. 16 shows a perspective view of a retainment system according to one aspect of the present disclosure.

FIG. 17 shows a partial perspective view of the retirement system in FIG. 16.

FIG. 18 shows a perspective view of an indicator system according to one aspect of the present disclosure.

FIG. 19 shows a sectional view of the indicator system in FIG. 18.

FIG. 20 shows a perspective view of an indicator system according to one aspect of the present disclosure.

FIG. 21 shows another perspective view of the indicator system in FIG. 20 in a different mode.

FIG. 22 shows a sectional view of the indicator system in FIG. 20.

FIG. 23 shows a section of view of the indicator system in FIG. 21.

FIG. 24 shows a perspective view of a retainment system according to one aspect of the present disclosure.

FIG. 25 shows a partial sectional view of FIG. 16.

FIG. 26 shows a perspective view of a retainment system according to one aspect of the present disclosure.

FIG. 27 shows a perspective view of the retainment system of FIG. 26.

FIG. 28 shows a sectional view of the retainment system of FIG. 26.

FIG. 29 shows an enlarged view of a portion of FIG. 28.

### DETAILED DESCRIPTION

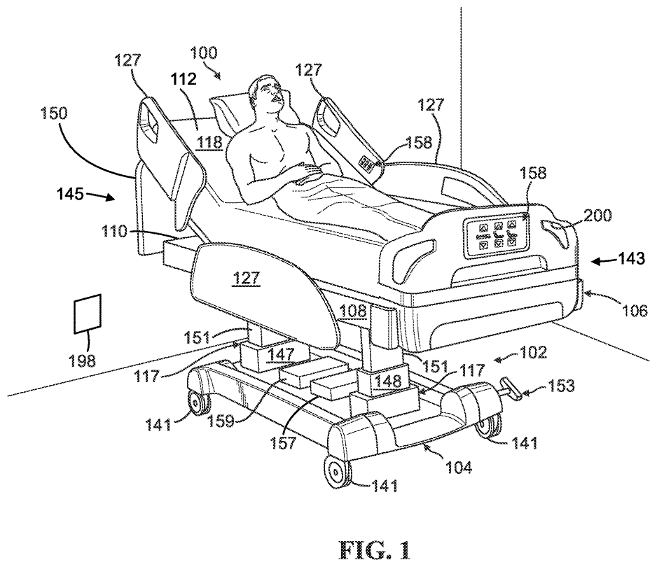

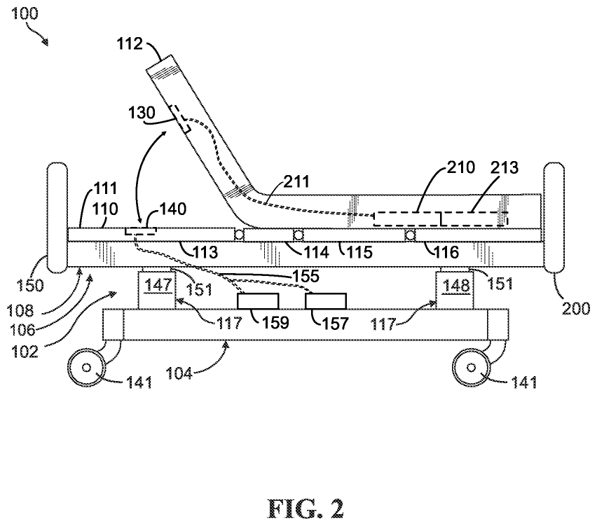

A patient support apparatus in accordance with one embodiment is depicted in FIGS. 1-2 and generally designated 100. The patient support apparatus 100 includes a support structure 102 that includes a base 104 and a litter 106, which includes an intermediate frame 108 and a patient support deck 110 spaced above the base 104. A lift assembly 117 may be provided between the base 104 and the intermediate frame 108 to facilitate moving the litter 106 relative to the base 104, such as raising and lowering the litter 106. It is to be understood that the litter 106 may be moved into a variety of positions, including but not limited to raised, lowered, and inclined positions.

The patient support deck 110 may be configured to support a patient support 112 on which a patient may be disposed. The patient support 112 may be a mattress and may be disposed on a deck surface 111 of the patient support deck 110. The patient support 112 may comfortably support the patient. It is to be understood that the patient support apparatus 100 may be implemented without a patient support 112 in the form of a mattress or with numerous alternatives for the mattress, such as cushions. The patient support 112 may be an air mattress according to one or more aspects described herein.

Although the particular form of patient support apparatus 100 illustrated in FIGS. 1-2 is a bed adapted for use in a hospital or other medical setting, it is to be understood that the patient support apparatus 100 may be a cot, a stretcher, a gurney, a recliner, an operating room table, or a residential bed or any other structure capable of supporting a patient, whether stationary or mobile and/or whether used in a medical or residential setting.

The patient support apparatus 100, as described herein, may include a mattress side coupler (e.g., a patient support side coupler) and a deck side coupler (e.g., an apparatus side coupler) operable to facilitate maintaining the patient support 112 in position relative to the deck 110. The patient support 112 (e.g., a mattress) may shift toward the foot end 143 of the patient support apparatus 100 under gravity and the motion of the Fowler. The mattress side coupler and the deck side coupler may facilitate retaining the position of the patient support 112 relative to the deck 110 in order to substantially prevent such shifting. The patient support apparatus 100 in one configuration may include electronics and/or electromechanical components, such as an internal pump, that utilizes at least one of 1) a power connection to enable related therapies and 2) a data connection for communication with the patient support apparatus, or components thereof (e.g., a control system 157). Mechanically retaining the patient support 112 and connecting the patient support 112 to power and/or data communication interfaces according to one aspect of the present disclosure may include such connections to enhance accessibility and reduce complexity. For instance, a system according to the present disclosure may avoid 1) separate straps for retaining the mattress to the Fowler, 2) having the user to feed the straps through the Fowler and a buckle, and 3) then tightening the straps. Instead, a system according to the present disclosure may provide a mattress side coupler and a deck side coupler that facilitate retention of the patient support 112 without significant effort from the caregiver or user. The system according to the present disclosure may also avoid separate cords for power and data connections that are separate from retention coupling between the patient support apparatus 100 and the patient support 112. A patient support apparatus 100 in one aspect may provide a single drop-in connection for mechanical and electrical connections between the patient support apparatus 100 and the patient support 112.

One or more aspects according to the present disclosure may provide various ways to enable mechanical retention of the patient support 112, while simultaneously providing a power and/or data connection to the patient support apparatus 100.

In one aspect, the patient support apparatus 100 may include a plurality of wheels 141 supporting the base 104 and litter 106. The wheels 141 may allow the patient support apparatus 100 to be easily moved along a surface (i.e., the floor). Alternatively, the patient support apparatus 100 may be implemented without wheels 141, such that the patient support apparatus 100 is relatively stationary. When implemented with wheels 141, the patient support apparatus 100 may include a brake 153 for immobilizing at least one of the wheels, including configurations where the brake immobilizes all of the wheels 141. The wheels 141 may form part of a castor assembly mounted to the base 104 and configured to swivel about a swivel axis while the wheels 141 rotate about a rotational axis. It is to be understood that the wheels 141 and associated castor assembly may vary from application to application and are not limited to the configuration described and depicted herein. For instance, the wheels 141 may be powered or unpowered, or additional wheels may be provided, or a combination thereof. Likewise, depending on the application, the brake 153 may be configured differently, or may be absent from the patient support apparatus 100.

The patient support 112 of the patient support apparatus 100 may provide a patient support surface 118 and may be supported on the deck surface 111 of the deck 110, which in turn is supported on the litter 106, which may be considered a frame.

The term “patient support” is used broadly herein and may refer to the whole mattress or cushion that supports a patient thereon or may refer to a portion of the mattress or cushion, such as a topper or an overlay, or to a separate device that can be used with a mattress or cushion, for example such as a pad to be placed on top of a mattress to provide treatment to a patient, such as low air loss, to move a patient, or to change the characteristic of the mattress or cushion, such as described below.

It is noted that the shape of the patient support 112 is defined based on the arrangement of the deck 110 and its sections as described herein. In one configuration without the patient support 112, the deck 110 itself may define the patient support surface 118.

The base 104, the litter 106, the intermediate frame 108, and the patient support deck 110 each may have a head end and a foot end corresponding to designated placement of the patient's head and feet on the patient support apparatus 100. It is to be understood that the specific configuration of the support structure 102 may take on any configuration and is not limited to that specifically illustrated and described herein.

The deck 110 may have one or more articulatable deck sections, including a back deck section (“Fowler”) 113, a seat deck section 114, a thigh deck section 115, and a foot section 116, which together with the litter 106 (e.g., a frame) are supported on the base 104 by a lift assembly 117. It is to be understood that the number and type of deck sections may be different depending on the application. For example, a thigh deck section 115 may be absent. As another example, the patient support deck 110 may be configured without a seat deck section 114 separate from the thigh deck section 115. Although the litter 106 illustrated herein includes an intermediate frame 108 to support the deck sections 113, 114, 115, 116 of the deck 110 for movement relative to the base 104 via the lift assembly 117, it is to be understood that various types of litters 106, with or without an intermediate frame 108 and/or with a differently-configured lift assembly 117, are within the scope of the present disclosure.

The lift assembly 117 in FIG. 1 may include a head end lift member 147 and a foot end lift member 148, which may be each arranged to facilitate movement of the litter 106 with respect to the base 104 using one or more lift actuators 151. The lift actuators 151 may be realized as linear actuators, rotary actuators, or other types of actuators, and may be electrically operated and/or may be hydraulic. In some configurations, only one lift member and one associated lift actuator may be employed, e.g., to raise only one end of the litter 106, or one central lift actuator to raise and lower the litter 106. The construction of the lift assembly 117, the head end lift member 147, and/or the foot end lift member 148 may vary depending on the application, and is not limited to the configuration shown and described herein. As an example, the lift assembly 117 may be configured as a “scissor” linkage arranged between the base 104 and the litter 106 with one or more actuators configured to facilitate vertical movement of the deck 110.

In one aspect, the patient support apparatus 100 may include one or more barriers, such as a footboard 200, a headboard 150, and a plurality of side rails 127. One of the side rails 127 proximal to the footboard 200 in FIG. 1 is shown in a lowered position in which ingress into, and egress out of, the patient support apparatus 100 is not obstructed by the lowered side rail 127. Each side rail 127 may be configured so it can be individually moved between a lowered position and a raised position. The side rails 127 may be moved to one or more intermediate positions as well. For purposes of disclosure, the side rails 127 are absent from the depiction of the patient support apparatus 100 in FIG. 2. It is to be understood that the number and configuration of the side rails 127 may be different from the depicted configuration. For instance, the linkage between the support structure 102 and the side rails 127 may vary depending on the application. As another example, one or more of the side rails 127 shown in FIG. 1 may be absent from the patient support apparatus 100. In yet another example, the positions of the one or more side rails 127 may be different, such as the side rail 127 proximal to the footboard 200 may be closer to or farther from the footboard 200.

It is to be understood that the patient support apparatus 100 may be modified from what is shown to include one or more components adapted to allow the user to extend the width of the deck 110, thereby allowing the patient support apparatus 100 to accommodate patients of varying sizes. For example, the width of the deck 110 may be adjusted, between a first width, a second or intermediate width, and a third or expanded width. The first width may be, for example, a 36 inch width, the second intermediate width may be, for example, a 42 inch width, and the third expanded width may be, for example, a 48 inch width, although these widths may be varied.

As used herein, the term “longitudinal” refers to a direction parallel to a central axis between a head end 145 and a foot end 143 of the patient support apparatus 100. The terms “transverse” or “lateral” refer to a direction perpendicular to the longitudinal direction and parallel to a surface on which the patient support apparatus 100 rests.

As described herein, power may be used to operate one or more powered devices disposed on the patient support apparatus 100, including a control system 157 of the patient support apparatus 100. The power can be provided by an external power source 198 and/or by a battery 159 operatively coupled to the support structure 102. The patient support apparatus 100 may include a connection system (not shown) that connects the patient support apparatus 100 to the external power source 198, which may take the form of utility power from wall outlet.

The patient support apparatus 100 may include a plurality of user interfaces configured similarly to the user interfaces 158 depicted in FIG. 1-although it is to be understood that the president disclosure is not limited to the specific configuration depicted in FIG. 1. The plurality of user interfaces 158 may be accessible by the patient, the caregiver, or by both the caregiver and the patient. Each user interface 158 of the patient support apparatus 100 may include an input device configured to generate an input signal in response to activation by a user which, in turn, is communicated to the control system 157. The control system 157, in turn, may be responsive to the input signal and may control or otherwise carry out one or more functions of the patient support apparatus 100 in response to receiving the input signal. In other words, the control system 157 may be configured to perform a function of the patient support apparatus 100 in response to receiving the input from the input device of the user interface 158. As an example, the user interface 158 may correspond to a “lift bed” button, the activation of which causes the control system 157 to drive the lift actuators 151 to move the intermediate frame 108 of the litter 106 from the maximum lowered configuration vertically away from the base 104 towards the raised configuration. Although the user interface 158 is described separate from the control system 157 and therefore may be separate from the control system 157, it is to be understood that the user interface 158 may form part of the control system 157.

Referring to FIG. 1, the patient support 112 may include a top layer, sometimes referred to as a topper, of a mattress. The patient support 112 may be integrated into an underlying mattress (and hence form a part of the mattress) or be placed on the mattress. The mattress itself may include a variety of different cushioning assemblies, e.g., an assembly or assemblies formed from foam, foam in combination with bladders, foam in combination with one or more gel layers, or foam in combination with bladders and one or more gel layers, and may include a control system incorporated into the patient support apparatus 100 or underlying cushioning components and contained, for example, proximal to the foot end 143 of the patient support apparatus 100 in a control housing, such as disclosed in U.S. Pat. Nos. 5,542,136;5,325,551; 7,406,736; 8,910,334(STR03A-P239A); U.S. Pat. No. 8,911,387(STR03A-P257A); U.S. Pat. No. 9,468,307(STR03A P400A); and U.S. Pat. No. 9,820,904(STR03A-P376A), which are commonly owned by Stryker Corporation of Kalamazoo, Michigan, and are incorporated by reference in their entireties herein.

Another example bladder cushioning assembly as well as a pneumatic control system is disclosed in commonly assigned U.S. patent applications Ser. Nos. 61/696,819, which is the provisional application to U.S. Non-Provisional application Ser. No. 13/836,813 (STR03A P400A), now U.S. Pat. No. 9,468,307, and 61/697,010, which is the provisional application to U.S. Non-Provisional application Ser. No. 14/019,353 (P-405E), now U.S. Pat. No. 9,420,895, entitled INFLATABLE MATTRESS AND CONTROL METHODS and PATIENT SUPPORT, respectively, both of which were filed on Sep. 5, 2012, which are hereby incorporated herein by reference in their entireties. Yet another example bladder cushioning assembly and pneumatic control system is disclosed in U.S. patent application Ser. No. 63/359,227 (P-A 676), entitled PATIENT SUPPORT APPARATUS WITH PATIENT SUPPORT SURFACES THEREFORE, filed Jul. 8, 2022.

The patient support 112, in one aspect, may include a low air loss system operable to receive air from a pneumatic system, which may be incorporated at least in part into one or both of an electronic system 210 and a mechanical system 213 of the patient support 112. For example, the low air loss system may include perforated tubing positioned between some of the bladders or other portions of the patient support 112 so as to direct air flow across or between the bladders or the other portions, which air flow would facilitate the removal of moisture from the patient's skin. Further, tubing or tube extensions or perforated bladders may be provided to extend up between the support bladders to direct air close to the support surface. Alternately, air loss conduits may be formed in the bladder layer, for example, the base sheet between the support bladders. In one aspect, the low air loss system may be incorporated into a cover for the patient support 112, where the cover receives air from the pneumatic system to remove moisture from the patient resting on the patient support 112. Such a cover may include a moisture permeable layer and a spacer material that supports an air space in the cover under the patient's weight to facilitate removal of moisture from the patient via directing air through the air space.

Additional to or alternative to the patient support 112 including bladders and/or a low-air-loss system that provides cushioning for the patient support 112, one or more turning bladders on each side of the patient support 112 may be inflated to provide patient turning capabilities (e.g., turn therapy). Turn bladders may be located under bladders and/or other cushioning aspects of the patient support 112 and may be inflated by the pneumatic system. In use, the turning bladders may be used for turning one side of the patient support 112 while the other remains generally stationary—though it should be understood that the bladders on the stationary side may have their pressure reduced to reduce their inflation to allow the person to immerse deeper into the surface while being turned to reduce the chances of a patient fall during turning. The turning bladders may be full length bladders that may extend substantially the full length of the patient support 112 or may be segmented. Further, the segment turning bladders may be independently inflated or deflated to allow access to a portion of a patient's body while being turned, or to affect a rolling turning effect, or just to turn a portion of the patient's body. For examples of optional controls for and examples of suitable turning bladders, reference is made to U.S. application Ser. No. 12/234,818, filed Sep. 22, 2008, now U.S. Pat. No. 8,296,887, entitled RESILIENT MATERIAL/AIR BLADDER SYSTEM; and U.S. application Ser. No. 11/891,451, filed Aug. 10, 2007, entitled TURN-ASSIST WITH ACCESS AREAS, which are incorporated herein by reference in their entireties. In one aspect, an enclosure may be provided or housed in a recessed portion of the patient support 112. The electronic system 210 and/or the mechanical system 213 may be provided in the enclosure. For instance, the enclosure may include a pump for directing air to the bladders and a controller for operating the pump.

In one aspect, the patient support 112 may include an electronic system 210 operable to receive power via a cable assembly 211, which may correspond to one or more wires or groups of wires that are bundled or unbundled. The electronic system 210 and/or the cable assembly 211 may be provided within the patient support 112, which may include an upper cover and a lower cover within which additional components of the patient support 112 (e.g., one or more bladders, foam, or gel-based elements) may be disposed.

In one aspect, the electronic system 210 may include a control system separate from the control system 157 of the patient support apparatus 100. For instance, the electronic system 210 may include a control system corresponding to a pneumatic controller for a pneumatic system described herein as part of one or more mechanical systems 213 coupled to the electronic system 210. Although the electronic system 210, or a control system thereof, is described separate from the control system 157 of the patient support apparatus—it is to be understood that a control system of the electronic system 210, another portion or portions of the electronic system 210, or the electronic system 210 as a whole, may form part of the overall control system 157 of the patient support apparatus 100.

The electronic system 210 may receive power via the cable assembly 211 of the patient support 112. The power may be received via the cable assembly 211 from an external source relative to the patient support 112, such as the battery 159 and/or the external power source 198. The power received via the cable assembly 211 may be converted and/or regulated relative to an output of the external source and may include more than one type of power source. For instance, the external source may supply 120 VAC as output power, and this output power may be conditioned into one or more DC voltages (e.g., 5V, 24V) prior to supply to the electronic system 210 via the cable assembly 211. Conductors of the cable assembly 211 may include a supply conductor and a return conductor (e.g., power and ground). Additionally, or alternatively, the power received via the cable assembly 211 may include power directly output from the external source (e.g., 120 VAC from the external power supply 198 or 24 VDC from the battery 159).

The electronic system 210 may receive data via the cable assembly 211 of the patient support 112. The cable assembly 211 may include one or more conductors operable to facilitate establishing communications for data between the electronic system 210 and the control system 157 of the patient support apparatus 100. As described herein, data may be communicated as discrete signals or serial communications, or a combination thereof, via one or more conductors of the cable assembly 211.

The electronic system 210 may include a communication interface operatively coupled to the cable assembly 211 to establish communications with the control system 157 of the patient support apparatus 100. The communication interface, as described herein, may enable data communication via one or both of discrete signals and serial communications. It is to be understood, however, that the communication interface is not so limited and that any type of interface for communicating data may be implemented in the electronic system 210. Non limiting examples of communication systems include SPI, I2C, CAN bus, and LIN bus, as well as other communication systems or methodologies described herein. The communication interface of the electronic system 210 may optionally be configured for wireless communication rather than wire-based communication via the cable assembly 211.

One or both of the control system 157 and the electronic system 210 may include any and all electrical circuitry and components to carry out the functions and algorithms described herein. Generally speaking, one or both of the control system 157 and the electronic system 210 may include one or more microcontrollers, microprocessors, and/or other programmable electronics that are programmed to carry out the functions described herein. One or both of the control system 157 and the electronic system 210 may additionally or alternatively include other electronic components that are programmed to carry out the functions described herein, or that support the microcontrollers, microprocessors, and/or other electronics. The other electronic components include, but are not limited to, one or more field programmable gate arrays, systems on a chip, volatile or nonvolatile memory, discrete circuitry, integrated circuits, application specific integrated circuits (ASICs) and/or other hardware, software, or firmware. Such components can be physically configured in any suitable manner, such as by mounting them to one or more circuit boards, or arranging them in other manners, whether combined into a single unit or distributed across multiple units. Such components may be physically distributed in different positions in the patient support apparatus 100, or they may reside in a common location within the patient support apparatus 100. When physically distributed, the components may communicate using any suitable serial or parallel communication protocol, such as, but not limited to: CAN, LIN, FireWire, I2C, RS-232, RS-422, RS-485, SPI, Ethernet, Universal Serial Bus (USB), and RF (cellular, WiFi, Bluetooth, Bluetooth Low Energy, Ultrawide Band).

The electronic system 210 may optionally be coupled to one or more mechanical systems 213, such as a pneumatic system that includes a pump assembly and tubing. The pneumatic system may be operably coupled to one or more fluid receiving portions or elements of the patient support 112, such as one or more bladders (e.g., support bladders or turning bladders) or a low air loss system as described herein. The pneumatic system may be operable to supply fluid to the fluid receiving portions of the patient support 112, or to receive fluid from the fluid receiving portions of the patient support 112, or both.

In one aspect, the pump assembly may be provided within the patient support 112 proximal to a foot end of the patient support 112. The pump assembly may include a housing within which a pump may be supported and operatively coupled to tubing of the pneumatic system. Alternatively, one or more components of the pneumatic system may be separate from the patient support 112, including, for example, separate from the patient support 112 but disposed on the patient support apparatus 100.

The pneumatic system may be operable to control inflation pressure of the one or more fluid receiving portions of the patient support 112. For instance, an electronic system (e.g., the electronic system 210) may direct operation of the pneumatic system and may control the inflation pressure of the one or more fluid receiving portions of the patient support 112. The electronic system 210 may be communicatively coupled to one or more of the user interfaces 158 via the cable assembly 211 as described herein. The electronic system 210 may be operable to receive input from a user via the user interfaces 158 with respect to one or more operational characteristics of the pneumatic system. As an example, the user interface 158 may receive and provide the electronic system 210 a directive to supply fluid to a bladder, such as a turning bladder, of the patient support 112 in order to increase a pressure thereof.

The mechanical system 213, in some aspects, is described as part of the patent support apparatus 100 and/or patient support 112. However, it is to be understood that one or more aspects of the mechanical system 213 may be separate and operable independent of the patient support apparatus 100 and/or the patient support 112.

The electronic system 210 may direct operation of the pneumatic system based on sensor information received from one or more sensors disposed on the patient support apparatus 100. Such sensors may include, but are not limited to, one or more depth sensors, fluid pressure sensors, temperature sensors, patient interface pressure sensors, and/or humidity sensors.

The pneumatic system, in one aspect, may include tubing that may be removably coupled to the patient support 112, via a removable coupling, in order to fluidly communicate with one or more fluid receiving portions of the patient support 112, such as a turning bladder or other type of inflatable bladder. The tubing may be operable to allow air (i.e., a type of fluid) to flow into and out of the patient support 112 via the removable coupling with the patient support 112. The tubing may be connected to the pump via a tubing connection provided on the pump housing of the pump assembly.

In one aspect, the patient support 112 may be both mechanically and electrically coupled to the patient support apparatus 100 via a coupling between a deck side coupler 140 and a mattress side coupler 130. The present disclosure is not limited to the deck side coupler 140 being disposed or provided on the deck 110 the deck side coupler 140 may be provided anywhere on the patient support apparatus 100 (including for instance the headboard 150) and so the deck side coupler 140 may be described as a patient support apparatus side coupler or support apparatus side coupler. Similar to the deck side coupler 140, the mattress side coupler 130 may be provided anywhere on a mattress. It is further to be understood that the present disclosure is not limited to the patient support 112 being a mattress, and so the mattress side coupler 130 is not limited to use on a mattress and may be described as a patient support side coupler 130.

The patient support 112, as described herein, may be removable relative to the patient support apparatus 100. Absent a mechanical coupling between the patient support 112 and the patient support apparatus 100, the patient support 112 may move out of position on the deck 110 during use. For instance, in circumstances where the Fowler deck section 113 of the deck 110 is moved toward an inclined position, both the weight of the patient support 112 and the patient may cause the patient support 112 to move out of position on the deck 110. Additionally, or alternatively, if a wiring harness or cable is provided between the patient support apparatus 100 and the patient support 112, absent some level of restraint therebetween, the wiring harness or cable can be strained and/or damaged during use due to movement of the patient support 112 on the deck 110.

The mattress side coupler 130 and the deck side coupler 140 may be operable to mechanically couple together in a manner that physically restrains movement of the patient support 112 in at least one direction relative to the patient support apparatus 100. As an example, the mechanical coupling between the mattress side coupler 130 and the deck side coupler 140 may substantially prevent lateral and longitudinal movement of the patient support 112 relative to the deck 110. Optionally, the deck side coupler 140 may allow the mattress side coupler 130 to move vertically and freely relative to the deck 110, leaving the mattress side coupler 130 unrestrained in the vertical direction. It is to be understood that a coupling between the deck side coupler 140 and the mattress side coupler 130 may be configured differently, such as by allowing the mattress side coupler 130 to move unrestrained in more than one direction.

The deck side coupler 140 may be disposed on the patient support apparatus 100 proximal to the headboard 150 to ease connection of the mattress side coupler 130 by a caregiver.

The mattress side coupler 130 and the deck side coupler on 140 may be configured to establish one or more electrical connections therebetween, providing one or more electrical connections between the patient support apparatus 100 and the patient support 112. The one or more electrical connections, as described herein, may facilitate transfer of power and/or communications between the patient support apparatus 100 and the patient support 112.

In FIG. 2, the mattress side coupler 130 is operatively connected to the cable assembly 211, and so an electronic system 210 may be connected to the mattress side coupler 130 via the cable assembly 211. The electronic system 210 may receive power and/or establish communications through one or more electrical connections provided by the mattress side coupler 130 to the deck side coupler 140.

The deck side coupler 140 may be connected to the control system 157 and a power source (such as the battery 159 and/or the external power source 198) via a cable assembly 155. The cable assembly 155 may provide additional or alternative electrical connections between the deck side coupler 140 and one or more components of the patient support apparatus 100. Through the coupling between the deck side coupler 140 and the mattress side coupler 130, both a mechanical connection and one or more electrical connections may be established between the patient support apparatus 100 and the patient support 112. The one or more electrical connections may facilitate establishing a communication link between the control system 157 of the patient support apparatus 100 and the electronic system 210 of the patient support 112. Additionally, the one or more electrical connections established between the deck side coupler 140 and the mattress side coupler 130 may facilitate providing power to the electronic system 210 via a power source (e.g., a battery 159 or the external power source 198).

Several configurations of the mattress side coupler and the deck coupler are described herein. It is to be understood that any of the described configurations may be implemented in conjunction with the patient support apparatus 100. Additionally, it is noted that any aspect of the various configurations of the mattress side coupler and the deck side coupler may be implemented in conjunction with another of such configurations described herein. It is further noted that any aspect of the various configurations of the mattress side coupler and the deck side coupler may be absent from one or more of such configurations, such that any aspect of a mattress side coupler and a deck side coupler may be implemented in another configuration without other aspects of the mattress side coupler and the deck side coupler. It is yet further noted that various configurations are described in conjunction with engagement elements being on one of the mattress side coupler and the deck side coupler—it is to be understood that present disclosure is not limited to an engagement element provided in such a configuration and that an engagement element on one of the mattress side coupler and the deck side coupler may be provided in an alternative configuration on the other of the mattress side coupler and the deck side coupler. As an example, according to one aspect of the present disclosure, a support side coupler may include a recess operable to receive an engagement body of a mattress side coupler and to restrain the mattress side coupler. Alternatively, the mattress side coupler may include the recess and the support side coupler may include the engagement body receivable by recess of the mattress side coupler.

### I. Mattress Side Coupler 130 and Deck Side Coupler 140

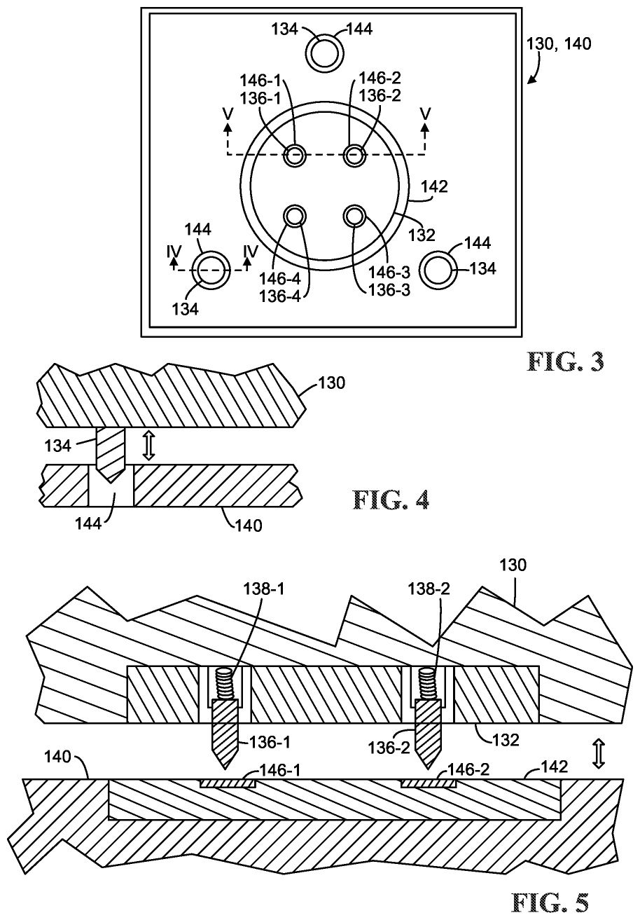

A mattress side coupler 130 and a deck side coupler 140 are depicted according to one configuration of the present disclosure in further detail in FIGS. 3-5. The mattress side coupler 130 and the deck side coupler 140, in a coupled configuration, may be configured to restrain movement of the patient support 112 in both lateral and longitudinal directions, while also establishing one or more electrical connections between the two to facilitate the supply of power to and/or data communications with the electronic system 210.

The mattress side coupler 130 and the deck side coupler 140 may form a connector of which one mating half is on the frame or deck 110 and the other is on the underside mattress/surface (e.g., a patient support 112). When the patient support 112 is laid on the deck 110, the two halves of the connector may connect. A magnetic or physical snap may be provided to aid in the connection and in contacts being made (e.g., electrical contact being made). For cleaning, the patient support 112 can be lifted off the deck.

The mattress side coupler 130 and the deck side coupler 140 may be configured to provide a coupling with restraint of a patient support 112 in at least one direction, potentially without mechanical interconnection between the mattress side coupler 130 and the deck side coupler 140. For instance, the mattress side coupler 130 may include one or more posts 134 that extend below a bottom surface of the patient support 112 and that are operable to be received in one or more respective sockets 144 of the deck side coupler 140. Under the weight of gravity of the patient support 112 and the patient, the one or more posts 134 may remain within one or more respective sockets 144 and restrain lateral and longitudinal movement of the patient support 112 relative to the deck 110.

The number and positions of the posts 134 and the sockets 144 may vary depending on the application. In FIGS. 3-5, there are three posts 134 and respective sockets 144. The positions may be arranged to facilitate coupling between the mattress side coupler 130 and the deck side coupler 140 in one orientation. However, it is to be understood that the present disclosure is not so limited and that the post 134 and respective sockets 144 may be arranged in any manner. The mattress side coupler 130 and the deck side coupler 140 are configured substantially flush with a bottom surface of the patient support 112 (e.g., flush with a lower cover of the patient support 112). This way, with the patient support 112 resting on the deck 110, the one or more posts 134 may be fully received within the sockets 144 and restrain lateral and longitudinal movement of the patient support 112 relative to the deck 110. The length of the plurality of post 134, the depth of the sockets 144, and the clearance therebetween (e.g., the gap between the diameters of the posts 134 and the sockets 144) may vary from application to application. The posts 134 and the sockets 144 are depicted as circular; however, the present disclosure is not so limited—any type of cylindrical shape may be utilized including square, hexagonal, and octagonal shapes. The mattress coupler may be mounted to the lower cover via welding, fastening, or clamping.

The mattress side coupler 130 may include a base structure (e.g., an enclosure or housing) operable to support the plurality of posts 134 extending from the base structure. The base structure may be polymer-based; however, any type of material may be used including non-polymer-based materials. The plurality of posts 134 may be polymer-based or non-conductive to avoid making conductive contact with electrical contacts 146 of the deck side coupler 140. It is to be understood, however, that the plurality of posts 134 may be formed of any type of material, including conductive or non-conductive materials.

The mattress side coupler 130, as depicted in FIGS. 3 and 5, includes a plurality of electrical contacts 136 (e.g., 136-1, 136-2 . . . 136-N). The plurality of electrical contacts 136 may be electrically coupled to the cable assembly 211, thereby providing a conductive connection between the electrical contacts 136 and the electronic system 210. The plurality of electrical contacts 136, in FIG. 5, are pogo pins with springs 138-1, 138-2 respectively operable to bias the plurality of electrical contacts 136 toward an extended position to substantially maintain electrical connections with a corresponding plurality of electrical contacts 146 (e.g., 146-1, 146-2 . . . 146-N) of the deck side coupler 140. The electrical contacts 136 of the mattress side coupler 130 may be supported by a contact body 132, and likewise, the electrical contacts 146 of the deck side coupler 140 may be supported by a contact body 142. The contact body 132 of the mattress side coupler 130 may rest against the contact body 142 of the deck side coupler 140 under the weight of the patient support 112, if the posts 134 are fully received within the sockets 144 of the deck side coupler 140. The electrical contacts 136 of the mattress side coupler 130 may retract under the load of the patient support 112, while maintaining electrical connections with respective electrical contacts 146 of the deck side coupler 140. Although the electrical contacts 136 in the form of spring-loaded contacts are shown provided by the mattress side coupler 130, it is to be understood that the present disclosure is not so limited. For instance, spring-loaded contacts may be provided by the deck side coupler 140 in addition to or alternative to spring-loaded contacts being provided by the mattress side coupler 130.

In one aspect, the deck side coupler 140 (and/or the mattress side coupler 130) may include a shielding cover on the deck side so that the electrical contacts 146 may be substantially protected from cleaning fluid during wipe down. When the mattress side coupler 130 (e.g., mattress half) makes contact, the mattress side coupler 130 may move the shielding cover out of place and expose the deck side coupler 140 and/or the electrical contacts 146 thereof.

The patient support 112 (e.g., a patient surface) may need to be lifted from the deck 110 for cleaning, and this can stress or fatigue cables and connectors that run between the patient support apparatus 100 and the patient support 112.

The mattress side coupler 130 and the deck side coupler 140 may provide an integral quick connect/disconnect system. This system may provide electrical connections for power and communication signals, including possible dedicated lines for eCPR operations. As described herein, a detector may be provided in conjunction with the mattress side coupler 130 on the deck side coupler 140. The communication signals provided via electrical connections between the couplers 130, 140 may provide a sensing signal or line circuit that enables the control system 157 and/or the electronic system 210 to detect that the mattress side coupler 130 and the deck side coupler 140 are connected.

It is noted that the present disclosure is not limited to the specific construction depicted in the figures and aspects described herein, and that additional mating features may be provided to substantially ensure firm location of the bottom of the patient support 112 with respect to the deck 110 so that the connecting parts (e.g., the mattress side coupler 130 and the deck side coupler 140) do not shift around during use. These may also aid in centering the two mating halves of the couplers.

One or both couplers may include a ‘float’ built in to aid in centering and connection. (e.g., the couplers may be mounted within oversized openings so that they can translate relative to the mattress or support and align more easily.) Additionally, or alternatively, large contact pads for the electrical contacts 136,146 on one or both halves may accommodate imperfect centering.

In one aspect, the electrical connections between the mattress side coupler 130 and the deck side coupler 140 may be utilized in conjunction with control signals for enabling CPR deflate. For instance, the control system 157 of the patient support apparatus 100 may include CPR functionality that is operable in response to activation of a CPR handle. For instance, in response to activation of the CPR handle, the control system 157 may communicate to the electronic system 210 to take action pertaining to a CPR event, such as to initiate deflation of one or more bladders. The communication may take the form of serial communication and/or a discrete signal (e.g., a control line) provided to the electronic system 210. In one aspect, the CPR handle may generate a discrete signal provided directly through the cable assemblies 155, 211, through the deck side and mattress side couplers 130, 140, and to the electronic system 210. In one aspect, an action such as a translating member (driven by the device CPR handle) may be used to activate a valve mechanism of the electronic system 210 and/or the mechanical system 213 on the bottom of the patient support 112.

### II. Mattress Side Coupler 230 and Deck Side Coupler 240

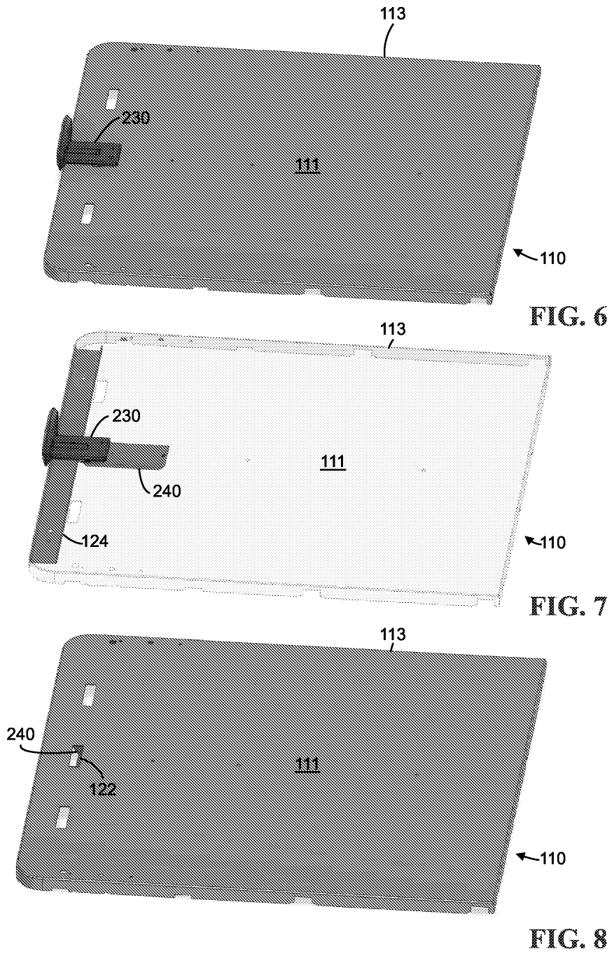

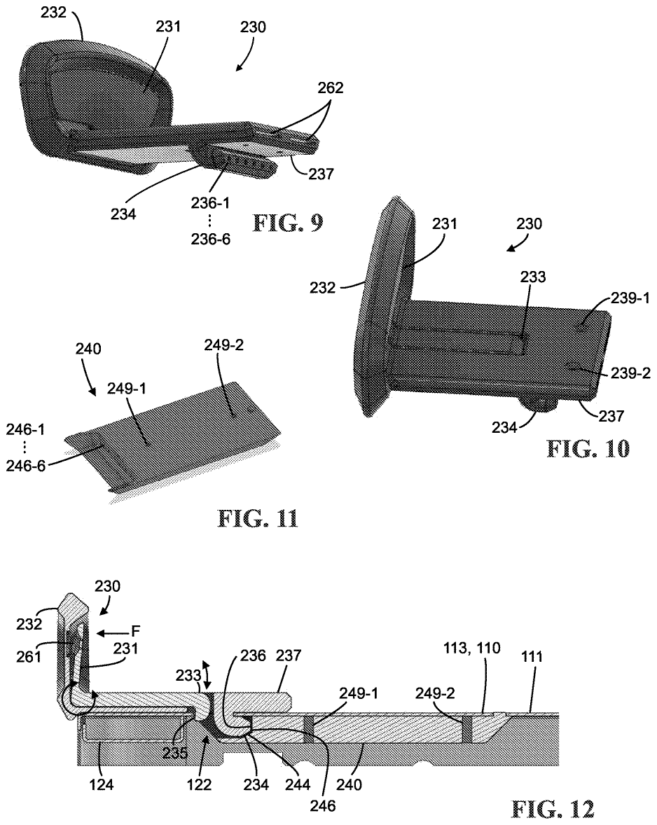

As described herein, the patient support apparatus 100 and the patient support 112 may utilize a mattress side coupler 130 and a deck side coupler 140 to facilitate both mechanical and electrical coupling between the patient support apparatus 100 and the patient support 112. The mechanical coupling may include restraining the mattress side coupler 130 relative to the deck side coupler 140 in at least one direction. In one aspect, the mattress side coupler 130 and the deck side coupler 140 may be replaced with a mattress side coupler 230 and a deck side coupler 240 described herein with respect to FIGS. 6-12. The mattress side coupler 230 may be connected to the cable assembly 211 and operable to mechanically and electrically couple to the deck side coupler 240, similar to the mattress side coupler 130. Likewise, the deck side coupler 240 may be connected to the cable assembly 155 and operable to mechanically and electrically couple to the mattress side coupler 230, similar to the deck side coupler 140. The coupling between the mattress side coupler 230 and the deck side coupler 240 may facilitate maintaining a position of the patient support 112 on the deck 110 of the patient support apparatus 100.

In one aspect, similar to the mattress side coupler 130 and the deck side coupler 140, the present disclosure is not limited to the deck side coupler 240 being disposed or provided on the deck 110—the deck side coupler 240 maybe provided anywhere on the patient support apparatus 100 (including for instance the headboard 150) and so the deck side coupler 240 may be described as a patient support apparatus side coupler or support apparatus side coupler. Similar to the deck side coupler 240, the mattress side coupler 230 may be provided anywhere on a mattress. It is further to be understood that the present disclosure is not limited to the patient support 112 being a mattress, and so the mattress side coupler 230 is not limited to use with a mattress and may be described as a patient support side coupler 130.

The deck side coupler 240 in FIGS. 7 and 11 may be coupled to a lower surface of the Fowler deck section 113 that is opposite the deck surface 111, and may be configured to operate in conjunction with the opening 122 and the deck 110 to facilitate coupling with the mattress side coupler. It should be understood that the position and configuration of the deck side coupler 240 may vary from application to application and is not limited to the placement depicted in FIGS. 7 and 11—for instance, the deck side coupler 240 may be connected to or associated with another section of the deck 110. The deck side coupler 240 may be connected to a deck section (e.g., the Fowler deck section 113) via fasteners, such as bolts or screws, received by openings 249-1, 249-2 provided in the deck side coupler 240 and operable to engage the deck 110 or a section thereof.

The Fowler deck section 113 (or another deck section of the deck 110) in FIGS. 6-8 includes an opening 122 aligned with the deck side coupler 240. The opening 122 may be pre-existing with respect to the deck 110. Alternatively, the opening 122 may be provided specifically for enabling coupling between the deck side coupler 240 and the mattress side coupler 230. In FIG. 7, a support beam 124 is provided proximal to a head end of the Fowler deck section 113 to reinforce the Fowler deck section 113 (e.g., to support against deflection or bending and/or to support a coupling between the mattress side coupler 230 and the deck side coupler 240).

As described herein, the mattress side coupler 230 may include an engagement body 234 (e.g., a finger or extension) receivable by the opening 122 and operable to engage the deck side coupler 240 to facilitate coupling the mattress side coupler 230 both mechanically and electrically to the deck side coupler 240.

The mattress side coupler 230 is shown in further detail in FIGS. 9, 10, and 12 and includes one or more aspects according to the present disclosure. The mattress side coupler 230 includes a handle 232 that a caregiver may utilize to manipulate and move the mattress side coupler 230 along with the patient support 112. The handle 232 may extend vertically from a base 237 of the mattress side coupler 230, which may contact the deck surface 111 of the deck 110 with the mattress side coupler 230 coupled to the deck side coupler 240. The handle 232 may be accessible to the caregiver proximal to the head end 145 of the patient support 112 with the patient support 112 disposed on the deck 110 and coupled to the patient support apparatus 100 via the mattress side coupler 230. This way, the caregiver can more easily access the handle 232 to facilitate manipulation of the mattress side coupler 230, including, for example, operating a release of the mattress side coupler 230 in order to decouple the mattress side coupler 230 from the deck side coupler 240.

An engagement element 234 may extend from a lower surface of the base 237 of the mattress side coupler 230. The engagement element 234 may be configured in a variety of ways depending on the application. In the representative view of the engagement element 234 depicted in FIGS. 9 and 12, the engagement element 234 corresponds to a finger that is received by the opening 122 and a receiver 244 of the deck side coupler for engagement therewith. The engagement element 234 may be sandwiched between the deck 110 and the deck side coupler 240, restraining movement of the engagement element 234 in both vertical and horizontal directions relative to the representative view in FIG. 12. Additionally, the opening 122 and the deck side coupler 240 may restrain movement of the mattress side coupler laterally with respect to the deck surface 111.

In the representative view of the mattress side coupler 230 and the deck side coupler 240 in FIG. 12, the engagement element 234 may slide into the opening 122 as the base 237 is moved along the deck surface 111 and toward engagement with the receiver 244 (e.g., as the base 237 is moved left to right relative to the illustration in FIG. 12). As the engagement element 234 is received by the opening 122, the base 237 may lower into contact with the deck surface 111 and a space between the base 237 and the engagement element 234 may receive at least a portion of the deck 110 to facilitate mechanical coupling between the deck side coupler 240 and the mattress side coupler 230.

It is to be understood that the engagement element 234 as well as the receiver 244 of the deck side coupler 240 may be configured differently to facilitate mechanical coupling between the mattress side coupler 230 and the deck side coupler 240, and that the present disclosure is not limited to any particular engagement mechanism between the mattress side coupler 230 and the deck side coupler 240.

The mattress side coupler 230 may include a latching mechanism 233 operable to engage an edge of the opening 122 to prevent removal of the mattress side coupler 230 from the deck side coupler 240 including removal from the opening 122. The latching mechanism 233 may include a catch 235 operable to engage the edge of the opening 122 with the engagement element 234 received within the receiver 244 of the deck side coupler 240. The catch 235 may prevent the engagement element 234 from sliding back out of the receiver 244 and the opening 122. The latching mechanism 233 may release the catch 235 to allow decoupling of the mattress side coupler 230 from the deck side coupler 240 by activation of the release 231. In the representative view of the mattress side coupler 230 and the deck side coupler 240, the release 231 of the latching mechanism 233 may be pushed via force F in the direction depicted in FIG. 12 toward the handle 232 in order to rotate the latching mechanism 233 and release the catch 235 from the edge of the opening 122. The latching mechanism 233 may be biased toward engagement of the catch 235 with the edge of the opening 122 via a spring 261 disposed between the handle 232 and the release 231 of the latching mechanism 233.

In the representative view of the deck side coupler 240 and the mattress side coupler 230, the mattress side coupler 230 includes a plurality of electrical contacts 236 (e.g., 236-1 . . . 236-N) similar to the electrical contacts 136 of the mattress side coupler 130. For instance, the plurality of electrical contacts 236 may include spring loaded contacts biased to an extended position to facilitate electrical engagement with a corresponding plurality of electrical contacts 246 (e.g., 246-1 . . . 246-N) of the deck side coupler 240. In a coupled position of the mattress side coupler 230, as depicted in FIG. 12, the electrical contacts 236 of the mattress side coupler 230 are engaged with and in electrical contact with the electrical contacts 246 of the deck side coupler 240. The electrical contacts 236, as described herein, may provide electrical connections for a variety of purposes, including, power, ground, or data signals, or a combination thereof.

The mattress side coupler 230 may be connected to the patient support 112 in a variety of ways, which include but are not limited to flexible and non-flexible connections.

For instance, the mattress side coupler 230 may include a plurality of openings 239 (e.g., 239-1 . . . 239-N) configured to receive a fastener (e.g., threaded fasteners such as a bolt or screw) to facilitate connecting directly to a lower cover of the patient support 112. The cover of the patient support 112 may be reinforced in an area corresponding to the fastener connection with respect to the mattress side coupler 230.

As another example, the mattress side coupler 230 may be attached to a strap (not shown but similar to the strap 750 shown in connection with the representative view in FIG. 24). The strap may restrain movement of the patient support 112 relative to the mattress side coupler 230 in at least one direction, so that the mattress side coupler 230 may restrain movement of the patient support 112 in at least one direction when coupled to the deck side coupler 240. For instance, the strap may limit movement of the patient support 112 along a direction from the head end to the foot end. Optionally, the strap and cable assembly 211 may be integral, such that the strap includes one or more electrical conductors for connection to the electronic system 210. The strap may be attached to the mattress side coupler 230 in a variety of ways, including, for example, a loop and pin coupling or a fastener connection with the plurality of openings 239.

The cable assembly 211 or conductors thereof may be routed through one or more openings 262 of the mattress side coupler 230 and connection to the plurality of electrical contacts 236. It is to be understood that the electrical connection between the cable assembly 211 and the plurality of electrical contacts 236 is not limited to any particular arrangement, and that any configuration that facilitates connection between the cable assembly 211 and the plurality of electrical contacts 236 may be utilized.

The mattress side coupler 230 (e.g., including a handle 232) may be mounted to the head-end of the patient support 112, either directly to the cover of the patient support 112 or indirectly via a strap. The mattress side coupler 230 may include a hook (e.g., an engagement body 234) integrated into the bottom that is configured to slide into the opening 122 in the Fowler deck section 113, aligning the patient support 112 to the frame and keeping it from sliding toward the foot end 142 when the Fowler deck section 113 is raised. The mattress side coupler 230 may include a spring-loaded latch mechanism that locks the hook (e.g., the engagement body 234) into the Fowler section 113 until a release button (e.g., the release 231) is depressed. In order to transfer power and data between the patient support 112 and the patient support apparatus 100, the deck side coupler 240 may include a power receptacle (e.g., a receiver 244) mounted to the underside of the Fowler section 113. This power receptacle may include multiple spring-loaded connectors (pogo pins) that engage with electrical contacts 236 (e.g., connectors) on the mating surface of the hook that protrudes through the Fowler section 113. This configuration may provide a single handle that simultaneously positions the mattress and provides a power and data connection.

### III. Mattress Side Coupler 330 and Deck Side Guide 350

As described herein, the patient support apparatus 100 and the patient support 112 may utilize a mattress side coupler 130 and a deck side coupler 140 to facilitate both mechanical and electrical coupling between the patient support apparatus 100 and the patient support 112. The mechanical coupling may include restraining the mattress side coupler 130 relative to the deck side coupler 140 in at least one direction. In one aspect, the mattress side coupler 130 and the deck side coupler 140 may be replaced with a mattress side coupler 330 and a deck side coupler 240 described herein with respect to FIGS. 6-15. The mattress side coupler 330 may be connected to the cable assembly 211 and operable to mechanically and electrically coupled to the deck side coupler 340, similar to the mattress side coupler 130. The mattress side coupler 330 may be configured to interface with an engage the deck side coupler 240 described herein. The coupling between the mattress side coupler 330 and the deck side coupler 240 may facilitate maintaining a position of the patient support apparatus 112 on the deck 110 of the patient support apparatus 100.

Similar to the mattress side coupler 230, the mattress side coupler 330 may be provided anywhere on a mattress. It is further to be understood that the present disclosure is not limited to the patient support 112 being a mattress, and so the mattress side coupler 330 is not limited to use a mattress and may be described as a patient support side coupler 130.

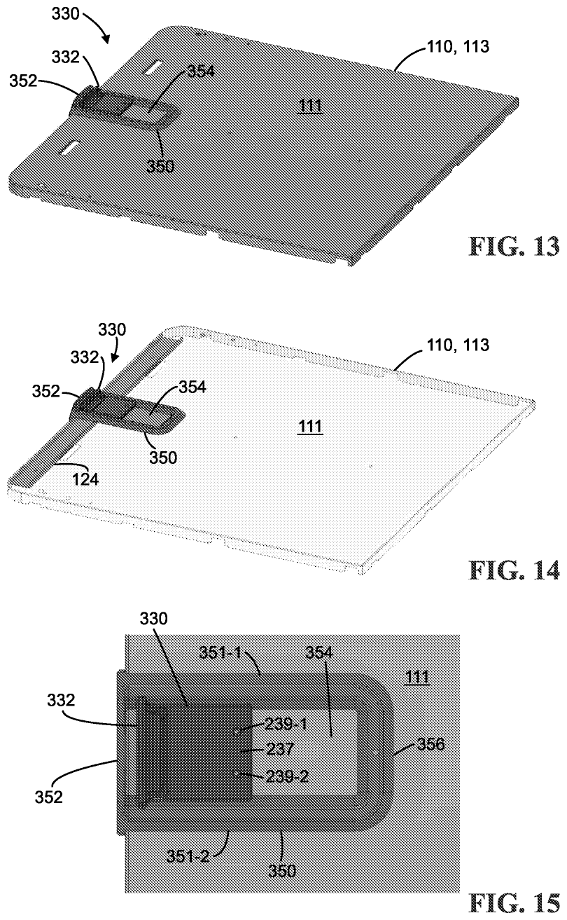

The deck side coupler 240 is coupled to a lower surface of the Fowler deck section 113 that is opposite the deck surface 111 in FIGS. 13-15, similar to the configuration depicted in FIGS. 6-12. For instance, the deck side coupler 240 may be aligned with and operate in conjunction with the opening 122 to couple with the mattress side coupler 230.

It should be understood that the position of the mattress side coupler 330 and the deck side coupler 240 may vary from application to application and is not limited to the placement depicted in FIGS. 7, 11, and 13-15. For instance, the deck side coupler 240 may be connected to or associated with another section of the deck 110. The deck side coupler 240 may be connected to a deck section (e.g., the Fowler deck section 113) via fasteners, such as bolts or screws, received by openings 239 provided in the deck side coupler 240 and operable to engage the deck 110 or a section thereof.

The mattress side coupler 330 may be similar to the mattress side coupler 230 in many respects but different in others. For instance, similar to the mattress side coupler 230, the mattress side coupler 330 may include a base 237 and an engagement element 234 operable to be received by the opening 122 and the receiver 244 of the deck side coupler 240. As another example, similar to the mattress side coupler 230, the mattress side coupler 330 may include a plurality of openings 239 capable of receiving a fastener for connection to the patient support 112. In yet another example, similar to the mattress side coupler 230, the mattress side coupler 330 may be coupled to the patient support via a strap, which may or may not include integral electrical conductors that connect to the cable assembly 211.

The mattress side coupler 330 in the representative views of FIGS. 13-15 may include a handle 332 similar in some respects to the handle 232 of the mattress side coupler 230. However, the mattress side coupler 330 may be configured without the latching mechanism 233 of the mattress side coupler 230, and therefore may not include the release 231. To facilitate maintaining the mattress side coupler 330 in a coupled position relative to the deck side coupler 240, a deck side guide 350 may be provided to guide and help maintain a position of the mattress side coupler 330 relative to the deck side coupler 240.

The deck side guide 350 in the representative views of FIGS. 13-15 includes a perimeter portion that defines a channel 354 operable to receive and guide the mattress side coupler 330. The deck side guide 350 may be disposed on the deck surface 111 and attached thereto. A perimeter portion of the deck side guide 350 may include opposing first and second sides 351-1, 351-2 spaced apart to define the channel 354 and an end portion 356 between the first and second sides 351-1, 351-2. The distance between the first and second sides 351-1, 351-2 may correspond substantially to a width of the mattress side coupler 330 so that the first and second sides 351-1, 351-2 of the channel guide 354 and restrain movement of the mattress side coupler 330.

The deck side guide 350 may include a stop 352 that extends upward from the deck surface 111, and is operable to contact and limit longitudinal movement of the mattress side coupler 330 past the stop 352. The stop 352 may also provide a leverage point for a caregiver to grab both the stop 352 and a handle 332 of the mattress side coupler 330 to decouple the mattress side coupler 330 from the deck side coupler 240. For instance, the caregiver may squeeze the handle 332 toward the stop 352 in order to move the mattress side coupler 330 longitudinally toward the stop 352 and the head end of the patient support apparatus 100. Such movement may decouple the engagement element 234 of the mattress side coupler 330 from the receiver 344 of the deck side coupler 240 and lift the engagement element 234 out of the opening 122 of the deck 110.

Attachment between the deck side guide 350 and the deck 110 may be provided via one or more fasteners, such as a threaded fastener or a snap fit fastener. It is to be understood however that attachment is not limited toward use of fasteners and that any type of attachment mechanism may be utilized.

The deck side guide 350 may be configured to guide the mattress side coupler 330 into the position on the Fowler section 113. The deck side guide 350 (e.g., a track) may align the mattress side coupler 330 laterally so that it is in line with the opening 122 in the Fowler section 113 of the deck 110. The deck side guide 350 may allow the handle to slide longitudinally so that the patient support 112 can be pulled toward the head-end 144 of the patient support apparatus 100 by pulling the mattress side coupler 330 within the track or channel 354 of the deck side guide 350. A hard stop 352 may be provided at the head-end of the track, and this stop 352 may stop the motion of the mattress side coupler 330 so that the hook (e.g., the engagement body 354) on the bottom can drop into the opening 122 on the Fowler section 113 of the deck 110, simultaneously connecting the patient support 112 to power and data. When the patient support 112 needs to be removed, the hook can be released with one hand by squeezing the handle 332 against the opposing surface on the deck side guide 350.

### IV. Mattress Side Coupler 430 and Deck Side Coupler 440

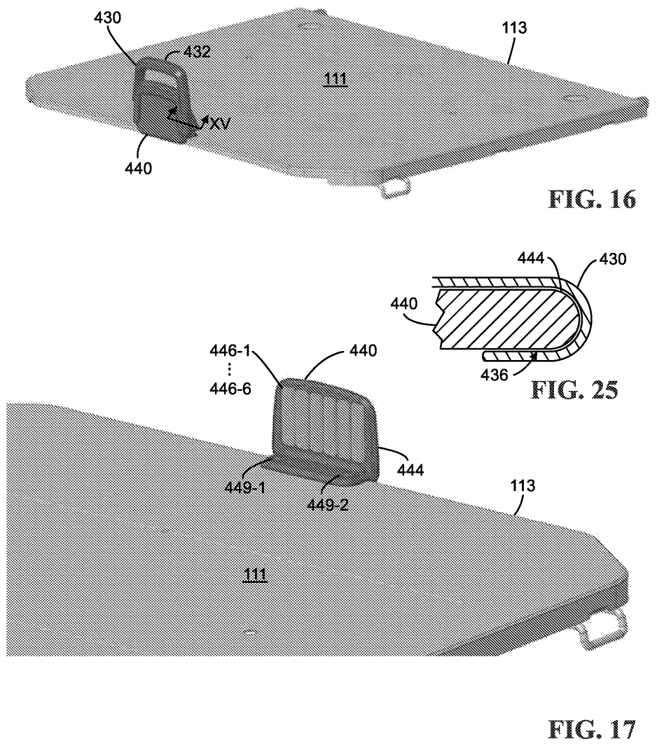

The patient support apparatus 100 and the patient support 112, as described herein, may utilize a mattress side coupler 130 and a deck side coupler 140 to facilitate both mechanical and electrical coupling between the patient support apparatus 100 and the patient support 112. The mechanical coupling may include restraining the mattress side coupler 130 relative to the deck side coupler 140 in at least one direction. In one aspect, the mattress side coupler 130 and the deck side coupler 140 may be replaced with a mattress side coupler 430 and a deck side coupler 440 described herein with respect to FIGS. 16-17. The mattress side coupler 430 may be connected to the cable assembly 211 and operable to mechanically and electrically couple to the deck side coupler 440, similar to the mattress side coupler 130. Likewise, the deck side coupler 430 may be connected to the cable assembly 155 and operable to mechanically and electrically couple to the mattress side coupler 430, similar to the deck side coupler 140. The coupling between the mattress side coupler 430 and the deck side coupler 440 may facilitate maintaining a position of the patient support 112 on the deck 110 of the patient support apparatus 100.

In one aspect, similar to the mattress side coupler 130 and the deck side coupler 140, the present disclosure is not limited to the deck side coupler 440 being disposed or provided on the deck 110—the deck side coupler 440 maybe provided anywhere on the patient support apparatus 100 (including for instance the headboard 150) and so the deck side coupler 440 may be described as a patient support apparatus side coupler or support apparatus side coupler. Similar to the deck side coupler 440, the mattress side coupler 430 may be provided anywhere on a mattress. It is further to be understood that the present disclosure is not limited to the patient support 112 being a mattress, and so the mattress side coupler 430 is not limited to use a mattress and may be described as a patient support side coupler 430.

The deck side coupler 440 in FIGS. 16-17 is coupled to the deck surface 111 and an end surface of the Fowler deck section 113. It should be understood that the position of the deck side coupler 440 may vary from application to application and is not limited to the placement depicted in FIGS. 16-17—for instance, the deck side coupler 440 may be connected to or associated with another section of the deck 110. The deck side coupler 440 may be connected to a deck section (e.g., the Fowler deck section 113) via fasteners, such as bolts or screws, received by openings 449-1, 449-2 provided in the deck side coupler 440 and operable to engage the deck 110 or a section thereof.

As described herein, the mattress side coupler 430 may be operable to slide over the deck side coupler 440 to receive a perimeter edge 444 of the deck side coupler 440 (e.g., an engagement body or element of the deck side coupler 440). A representative view of the coupling between the mattress side coupler 430 and the deck side coupler 440 is depicted in FIG. 25, with the perimeter edge 444 of the deck side coupler 440 received by a receiver 436 of the mattress side coupler 430. The receiver 436 of the mattress side coupler 430 may be defined by a gap between front and rear sides of the mattress side coupler 430. It is to be understood that the receiver 436 and the perimeter edge 444 of the deck side coupler 440 may be configured differently to facilitate coupling between the mattress side coupler 430 and the deck side coupler 440. The coupling between the receiver 436 and the perimeter edge 444 may restrict movement of the mattress side coupler 430 in at least one direction, including longitudinally and laterally with respect to the patient support apparatus 100.

The mattress side coupler 430 and the deck side coupler 440 may be configured such that an engagement element or body of the combination is provided on the deck side coupler 440. However, it is to be understood that the present disclosure is not so limited and that the engagement element or body may be provided on the mattress side coupler 430. For instance, the mattress side coupler 430 may include a receiver, similar to the receiver 436, that receives a perimeter edge similar to the perimeter edge 444. In other words, the coupling configuration of the mattress side coupler 430 and the deck side coupler 440 may be reversed.

In one aspect, the mattress side coupler 430 includes a handle 432 that a caregiver may utilize to manipulate and move the mattress side coupler 430 along with the patient support 112. The handle 432 may extend vertically from a base structure of the mattress side coupler 430. The handle 432 may be accessible to the caregiver proximal to the head end of the patient support 112 with the patient support 112 disposed on the deck 110 and coupled to the patient support apparatus 100 via the mattress side coupler 430. This way, the caregiver can more easily access the handle 432 to facilitate manipulation of the mattress side coupler 430.

In the representative view of the deck side coupler 240 and the mattress side coupler 230, the mattress side coupler 430 includes a plurality of electrical contacts similar to the electrical contacts 136 of the mattress side coupler 130. For instance, the plurality of electrical contacts may include spring loaded contacts biased to an extended position to facilitate electrical engagement with a corresponding plurality of electrical contacts 446 (e.g., 246-1 . . . 246-N) of the deck side coupler 440. In a coupled position of the mattress side coupler 430, as depicted in FIG. 16, the electrical contacts of the mattress side coupler 430 are engaged with and in electrical contact with the electrical contacts 446 of the deck side coupler 440. The electrical contacts of the mattress side coupler 430, as described herein, may provide electrical connections for a variety of purposes, including, power, ground, or data signals, or a combination thereof.

The mattress side coupler 430, like the mattress side coupler 230, may be connected to the patient support 112 in a variety of ways, which include but are not limited to flexible and non-flexible connections.

For instance, the mattress side coupler 430 may include a plurality of apertures configured to receive a fastener (e.g., a threaded fastener such as a bolt or screw) to facilitate connecting directly to a lower cover of the patient support 112. The cover of the patient support 112 maybe reinforced in an area corresponding to the fastener connection with respect to the mattress side coupler 430.

As another example, similar to the mattress side coupler 230, the mattress side coupler 430 may be attached to a strap, which may restrain movement of the patient support 112 relative to the mattress side coupler 430 in at least one direction. This way, the mattress side coupler 430 may restrain movement of the patient support 112 in at least one direction when coupled to the deck side coupler 440. Optionally, the strap and cable assembly 211 may be integral, such that the strap includes one or more electrical conductors for connection to the electronic system 210. The strap may be attached to the mattress side coupler 430 in a variety of ways, including, for example, a loop and pin coupling or a fastener connection with the plurality of apertures.

The cable assembly 211 or conductors thereof may be routed through one or more openings of the mattress side coupler 430 for connection to the plurality of electrical contacts thereof. It is to be understood that the electrical connection between the cable assembly 211 and the plurality of electrical contacts of the mattress side coupler 430 is not limited to any particular arrangement, and that any configuration that facilitates connection between the cable assembly 211 and the plurality of electrical contacts of the mattress side coupler 430 may be utilized.

The deck side coupler 440 (e.g., a mattress retainer) can be mounted anywhere around the perimeter of the bed frame (e.g., around the deck 110). The mattress side coupler 430 (e.g., a mattress retainer cap) may be mounted to the patient support 112 (e.g., a mattress), either directly to the cover of the patient support 112 or via a strap (e.g., the strap 750). The mattress side coupler 430 may be configured to slide vertically over the deck side coupler 440 and to capture it on four sides, so that it substantially locks all lateral and longitudinal motion. In order to transfer power and data between the patient support 112 and the patient support apparatus 100 (e.g., the frame), there are multiple spring-loaded electrical connectors (e.g., pogo pins) on the inside of the mattress side coupler 430, and large plate connectors (e.g., electrical contacts 446) on a mating surface of the deck side coupler 440. The plate connectors (e.g., electrical contacts 446) may be large enough to allow the deck side coupler 430 to slide vertically without breaking the electrical connection with the electrical contacts of the deck side coupler 430. This may allow the patient support 112 to continue to receive power and data even when it lifts off the frame, such as during turn assist or other therapies.

### V. Mattress Side Coupler 830 and Deck Side Coupler 840

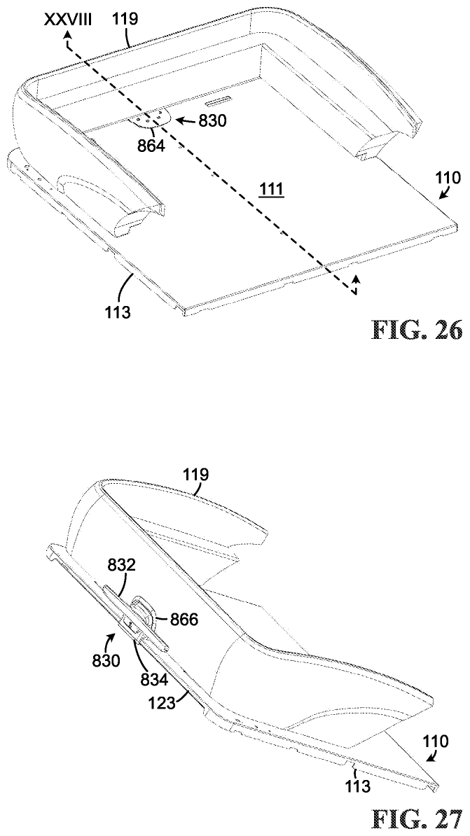

As described herein, the patient support apparatus 100 and the patient support 112 may utilize a mattress side coupler 130 and a deck side coupler 140 to facilitate both mechanical and electrical coupling between the patient support apparatus 100 and the patient support 112. The mechanical coupling may include restraining the mattress side coupler 130 relative to the deck side coupler 140 in at least one direction. In one aspect, the mattress side coupler 130 and the deck side coupler 140 may be replaced with a mattress side coupler 830 and a deck side coupler in the form of an opening 122 of the deck 110. This configuration of the mattress side coupler 830 and the opening 122 are described herein with respect to FIGS. 26-29. The mattress side coupler 830 in FIGS. 26-29 is not connected to a cable assembly and is not operable to provide a data and/or power connection to the patient support apparatus 100. However, it is to be understood that the mattress side coupler 830 may be configured differently to provide a connection to a cable assembly and to provide a data and/or power connection 100 between the mattress side coupler 830 and a deck side coupler according to one or more embodiments described herein.

For purpose of disclosure, a portion 119 of the patient support 112 is depicted in FIGS. 26-29. The portion 119 of the patient support 112 may include rigid or semi-rigid structural aspects of the patient support 112 proximal to the perimeter of the patient support 112. For instance, the portion 119 of the patient support 112 may correspond to a foam portion of the patient support 112.

In one aspect, the mattress side coupler 830 may be operable to mechanically couple to the opening 122, similar to the mattress side coupler 130. The coupling between the mattress side coupler 830 and the opening 122 may facilitate maintaining a position of the patient support 112 on the deck 110 of the patient support apparatus 100.

In one aspect, similar to the mattress side coupler 130 and the deck side coupler 140, the present disclosure is not limited to a deck side coupler in the form of the opening 122 being disposed or provided on the deck 110—the deck side coupler may be provided anywhere on the patient support apparatus 100 (including for instance the headboard 150) and so the deck side coupler may be described as a patient support apparatus side coupler or support apparatus side coupler. Additionally, or alternatively, the mattress side coupler 830 may be provided anywhere on a mattress. It is further to be understood that the present disclosure is not limited to the patient support 112 being a mattress, and so the mattress side coupler 830 is not limited to use with a mattress and may be described as a patient support side coupler.

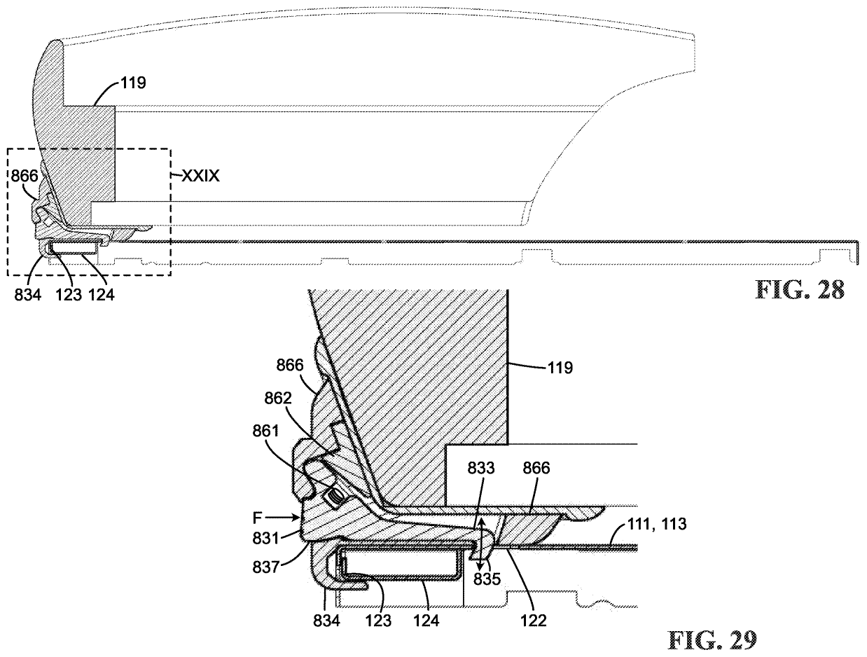

The Fowler deck section 113 (or another deck section of the deck 110) in FIGS. 26-29 includes the opening 122. The opening 122 may be pre-existing with respect to the deck 110. Alternatively, the opening 122 may be provided specifically for enabling coupling between the deck side coupler 840 and the deck 110. In FIGS. 28-29, a support beam 124 is provided proximal to a head end of the Fowler deck section 113 to reinforce the Fowler deck section 113 (e.g., to support against deflection or bending and/or to support a coupling between the mattress side coupler 830 and the opening 122).

As described herein, the mattress side coupler 830 may include an engagement body 234 (e.g., a finger or extension) operable to engage a perimeter edge 123 of the deck 110 to facilitate coupling the mattress side coupler 830 mechanically to the deck 110. In one aspect, the opening 122 and the perimeter edge 123 may together provide a deck side coupler configuration for the deck 110.

The mattress side coupler 830 is shown in further detail in FIGS. 27-29 and includes one or more aspects according to the present disclosure. The mattress side coupler 830 includes a handle 832 that a caregiver may utilize to manipulate and move the mattress side coupler 830 along with the patient support 112. The handle 832 may extend laterally relative to sides of the patient support 112 to facilitate manual manipulation of the patient support 100 relative to the deck 110. The handle 832 may be accessible to the caregiver proximal to the head end 145 of the patient support 112 with the patient support 112 disposed on the deck 110 and coupled to the patient support apparatus 100 via the mattress side coupler 830. This way, the caregiver can more easily access the handle 832 to facilitate manipulation of the mattress side coupler 830, including, for example, operating a release of the mattress side coupler 830 in order to decouple the mattress side coupler 830 from the deck 110.

An engagement element 834 may extend from a lower surface of a base 837 of the mattress side coupler 830. The engagement element 834 may be configured in a variety of ways depending on the application. In the representative view of the engagement element 834 depicted in FIGS. 28 and 29, the engagement element 834 corresponds to a finger that engages the perimeter edge 123 of the deck 110. The engagement element 834 may capture the perimeter edge 123 of the deck 110, restraining movement of the engagement element 834 in a vertical direction and in a horizontal direction toward the perimeter edge 123 relative to the representative view in FIG. 29.

In the representative view of the mattress side coupler 830 and the deck 110, the engagement element 834 may slide over the peripheral edge 123 of the deck 110 as the base 237 is moved along the deck surface 111 and toward engagement with the opening 122. As the peripheral edge 112 is received by the engagement element 834, the base 837 may slide toward the opening 122.

It is to be understood that the engagement element 834 may be configured differently to facilitate mechanical coupling between the mattress side coupler 830 and the deck 110, and that the present disclosure is not limited to any particular engagement mechanism between the mattress side coupler 830 and the deck 110.

The mattress side coupler 830, in one aspect, may include a latching mechanism 833 operable to engage an edge of the opening 122 to prevent removal of the mattress side coupler 830 from the deck 110 including removal from the opening 122. The latching mechanism 833 may include a catch 835 operable to engage the edge of the opening 122 with the engagement element 834 receiving therein the perimeter edge 123 of the deck 110. The catch 835 may prevent the engagement element 834 from disengaging the perimeter edge 123 of the deck 110. The latching mechanism 833 may release the catch 835 to allow decoupling of the mattress side coupler 230 from the deck 110 by activation of a release 831. In the representative view of the mattress side coupler 830, the release 831 of the latching mechanism 833 may be pushed via force F in the direction depicted in FIG. 29 toward the deck 110 in order to rotate the latching mechanism 833 and release the catch 835 from the edge of the opening 122. The latching mechanism 833 may be biased toward engagement of the catch 835 with the edge of the opening 122 via a spring 861 disposed between the latching mechanism 833 and a coupler component 862 of the mattress side coupler 830.

The mattress side coupler 830 may be connected to the patient support 112 in a variety of ways, which include but are not limited to flexible and non-flexible connections.

For instance, the mattress side coupler 830 may couple to the patient support 112 via support coupler 864, which may be fastened (e.g., via screws) to a main body 866 of the mattress side coupler 830. The cover of the patient support 112 may be reinforced in an area corresponding to the connection between the main body 866 and the support coupler 864.

As another example, the mattress side coupler 830 may be attached to a strap (not shown but similar to the strap 750 shown in connection with the representative view in FIG. 24). The strap may restrain movement of the patient support 112 relative to the mattress side coupler 830 in at least one direction, so that the mattress side coupler 830 may restrain movement of the patient support 112 in at least one direction when coupled to the deck 110. For instance, the strap may limit movement of the patient support 112 along a direction from the head end to the foot end. The strap may be attached to the mattress side coupler 830 in a variety of ways, including, for example, a loop and pin coupling or a fastener connection.

The mattress side coupler 830 (e.g., including the handle 832) may be mounted to the head-end of the patient support 812, either directly to the cover of the patient support 112 or indirectly via a strap. The mattress side coupler 830 may include a hook (e.g., a latching mechanism 833 and/or an engagement element 834) integrated into the bottom that is configured to slide into the opening 122 in the Fowler deck section 113, aligning the patient support 112 to the frame and keeping it from sliding toward the foot end 142 when the Fowler deck section 113 is raised. The mattress side coupler 830 may include a spring-loaded latch mechanism that locks the hook (e.g., the latching mechanism 833) into the Fowler section 113 until a release button (e.g., the release 831) is depressed.

### VI. Indicator System

The patient support apparatus 100 and the patient support 112 may utilize a mattress side coupler 130 and a deck side coupler 140 to facilitate both mechanical and electrical coupling between the patient support apparatus 100 and the patient support 112. It is to be understood that the present disclosure is not limited toward a coupling that provides both mechanical and electrical coupling. For instance, any coupling described herein may include or provide only one of mechanical or electrical coupling. Additionally, or alternatively, with respect to a coupling providing one or both mechanical and electrical coupling, the coupling between a mattress side coupler and a deck side coupler may include an indicator system configured to identify engagement of the coupling between the mattress side coupler and the support side coupler.

It is noted that hospital bed users can forget to properly retain the patient support 112 to the patient support apparatus 100 because retainment points for the patient support 112 can be obscured from view and it may not be clear if a retainment step has been missed. When the patient support 112 is not properly retained, it can shift out of its intended position, compromising the therapeutic value and comfort of the patient support 112.

An indicator system 500, such as a switch, can be provided in conjunction with a retainment point for the patient support 112 to allow the patient support apparatus 100 to provide an indication (e.g., an alert or a convenient reminder) when the patient support 112 is not properly retained. The indicator system 500 may direct the patient support apparatus 100 to intentionally disable functionality to prevent such operation without the patient support 112 being retained. This can make the patient support apparatus 100 easier to use and help ensure that the therapeutic value and comfort of the patient support 112 is not substantially compromised.

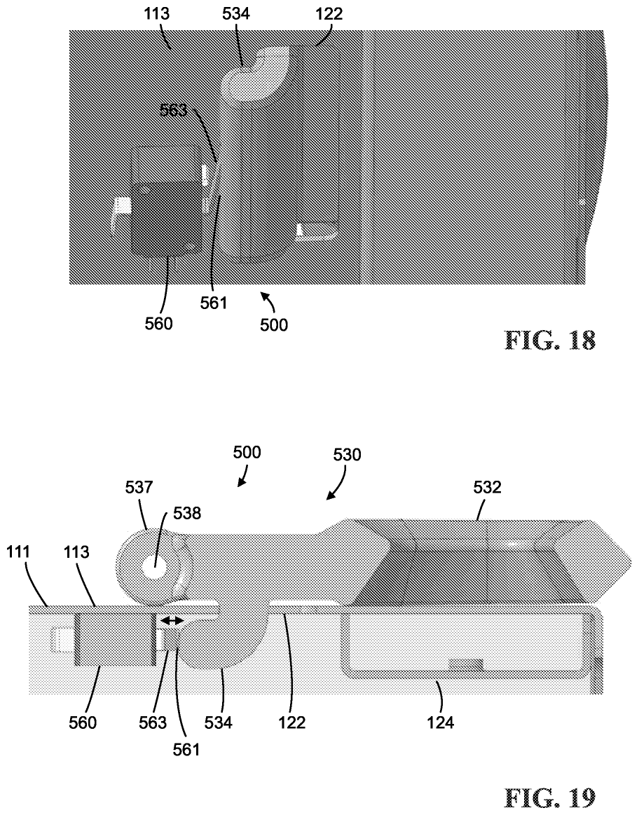

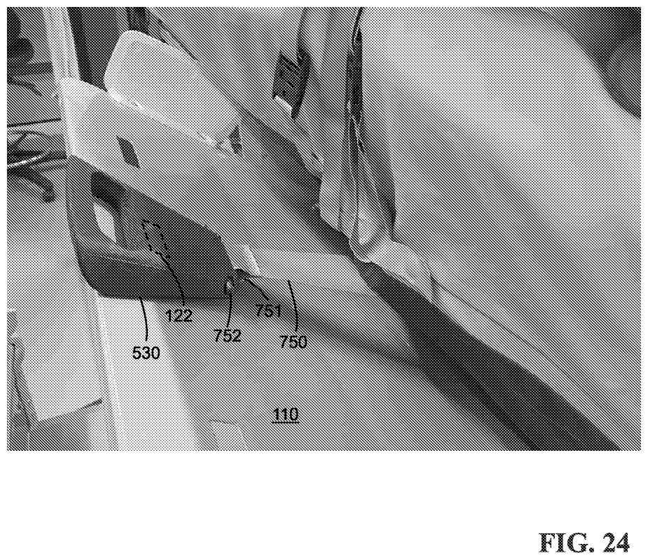

The indicator system 500 may be incorporated into any configuration described herein. In the representative configuration depicted in FIGS. 18 and 19, the indicator system 500 may include a detector 560 operable to detect a target associated with the patient support 112. Detection of the target 561 may be used as a basis for identifying presence of the patient support 112 relative to the patient support apparatus 100. Additionally, or alternatively, detection of the target 561 may be used as a basis for identifying engagement of a coupling between the mattress side coupler 130, 230, 330, 430 and the deck side coupler 140, 240, 340, 440. The detector 560 may be operably coupled to the patient support apparatus 100, and the target 561 may be operably coupled to the patient support 112. It is to be understood that the positions of the detector 560 and the target 561 may be different, such as with the detector 560 being disposed on the patient support 112 and the target 561 being disposed on the patient support apparatus 100.

In order to detect when the patient support 112 has been properly attached to the patient support apparatus 100 (e.g., to a frame thereof), a mattress retainment system, such as the mattress side coupler and a deck side coupler, may include at least one switch, proximity sensor, pressure sensor, or photoelectric laser sensor. In a configuration including a switch, the switch may be mounted to the frame and only depressed when the mattress retainment hook (e.g., the engagement body 534) is properly attached. Alternatively, the switch may be mounted to the mattress retainment system so that it is only depressed when the mattress side coupler 530 is attached to the frame. When the switch detects that the patient support 112 is not properly retained, a variety of actions may be taken, including and without limitation one or more of the following:
Display messages or graphics on screens of one or more user interfaces 158, e.g., footboard 200 may read “Please attach the head end mattress retainer” and shows an image of how to attach it;
Intentionally limit functionality of the patient support apparatus 100, e.g., disable allowing the mattress to perform turn assist and disable allow the Fowler to raise;
Use lights to indicate status, e.g., lights or indicators may turn amber when the mattress is not properly retained;
Use speakers to indicate status, e.g., an audio recording may state, “Please attach the head end mattress retainer.” In the representative views of FIGS. 18, 19, and 24, the indicator system 500 may be provided in conjunction with a mattress side coupler 530 operable to facilitate coupling the patient support 112 to the patient support apparatus 100 in conjunction with the opening 122 in order to restrain movement of the mattress side coupler 530 in at least one direction relative to the patient support apparatus 100. As described herein, the mattress side coupler 530 may be directly coupled (e.g., a direct mounting via fasteners) or indirectly coupled (e.g., a strap) to the patient support 112. More specifically, in FIG. 24, the mattress side coupler 530 can be seen indirectly coupled to a lower portion (e.g., a lower cover) of the patient support 112 via a strap 750. The strap 750 may be flexible and may be coupled to the mattress side coupler 530 via a coupling between a loop 751 of the strap 750 and a pin 752. The mattress side coupler 530 may include a receiver 538 for the pin 752 to maintain the connection with the strap 750. It is to be understood that the present disclosure is not limited to a flexible strap 750 according to FIG. 25, and that any type of link between the mattress side coupler 530 and the patient support 112 may be utilized. It is to be further understood that the present disclosure is not limited to the configuration of FIG. 24 including the indicator system 500 for instance, the mattress side coupler 530 may be utilized to couple the patient support 110 to the patient support apparatus 100 without the detector 560 of the detection system 500. Additionally, it is noted that, in a configuration including electrical contacts in the mattress side coupler 530, the strap 750 may include electrical conductors connected between the electrical contacts of the mattress side coupler 530 and the cable assembly 211 of the patient support 112.

The mattress side coupler 530 may be similar to the mattress side coupler 230 in the many respects for mechanically coupling the patient support 112 to the patient support apparatus 100 period. The opening 122 in the representative view may operate as a deck side coupler, similar to the deck side coupler 240 without a receiver 244. It is noted that the opening 122, itself, may form the deck side coupler in any of the configurations described herein without a receiver 244.

In an alternative configuration, the mattress side coupler 530 may be connected to the cable assembly 211 to electrically couple a receiver 244 of a deck side coupler configured accordingly, similar to the mattress side coupler 230 and the deck side coupler 240. The coupling between the mattress side coupler 530 and the deck side coupler in the form of the opening 122 and the deck 110 may facilitate maintaining a position of the patient support apparatus 112 on the deck 110 of the patient support apparatus 100.

In one aspect, the present disclosure is not limited to the mattress side coupler 530 being disposed or provided on the patient support 112. The mattress side coupler 530 may be provided anywhere on a mattress. It is further to be understood that the present disclosure is not limited to the patient support 112 being a mattress, and so the mattress side coupler 530 is not limited to use a mattress and may be described as a patient support side coupler 530.

The mattress side coupler 530 may include a base 537, a handle 532, and an engagement body 534, similar respectively to the base 237, the handle 232, and the engagement body 234 of the mattress side coupler 230.

The detector 560 may include an actuator 563 that is movable in response to contact with the engagement body 534. For instance, as the engagement body 534 is received by the opening 122 and engages an edge thereof (e.g., as a deck side coupler), a target portion of the engagement body 534 identified as the target 561 may contact and move the actuator 563 of the detector 560. The detector 560 may be an electronic component configured such that movement of the actuator 563 of the detector 560 may generate a detection signal indicative of activation of the actuator 563. The detection signal may be provided to the control system 157 via the cable assembly 155, enabling the control system 157 to operate according to the detection signal. Example actions or functions pertaining to the detection signal include enabling or disabling inflation of bladders within the mattress, enabling or disabling bed motion functions, enabling or disabling informational messages on displays, or enabling or disabling functions on a touch screen.

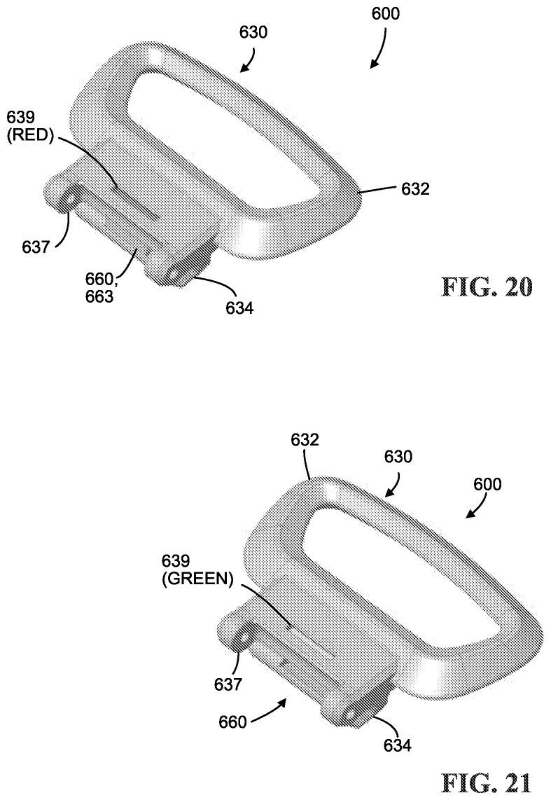

A detector system 600 according to one or more aspects of the present disclosure is depicted in FIGS. 20-23. The detector system 600 may be similar in many respects to the detector 560 described herein, including being operable to detect a target 661 associated with the patient support 112. Detection of the target 661 may be used as a basis for identifying presence of the patient support 112 relative to the patient support apparatus 100. Additionally, or alternatively, detection of the target 661 may be used as a basis for identifying engagement of a coupling between the mattress side coupler 130, 230, 330, 430, 530 and the deck side coupler 140, 240, 340, 440. The detector 660 may be operably coupled to the patient support apparatus 100, and the target 661 may be operably coupled to the patient support 112. It is to be understood that the positions of the detector 660 and the target 661 may be different, such as with the detector 660 being disposed on the patient support 112 and the target 661 being disposed on the patient support apparatus 100.

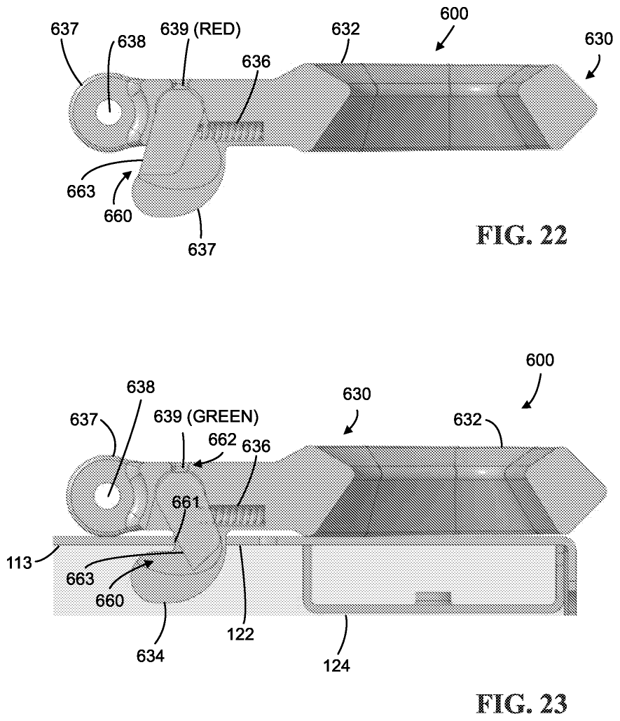

In one aspect, the mattress retainment system (e.g., a mattress side coupler 630 and the opening 122) may include a lever (e.g., an actuator 663) that is spring biased. When the retainment system is not attached to the deck 110 or frame, the lever sits in position 1 shown in FIG. 22, and when the retainment system is properly attached the lever is pushed into position 2 shown in FIG. 23. A window 662 may be provided on the housing that allows the user to see surface 1 (e.g., red) of the lever when it is in position 1, and that allows the user to see surface 2 (e.g., green) of the lever when it is in position 2. These two surfaces on the lever can be color-coded or covered in graphics to communicate when the mattress retainment system is properly installed, e.g., green when it is properly installed, red when it is not installed.

In the representative views of FIGS. 20 and 23, the indicator system 600 may be provided in conjunction with a mattress side coupler 630 operable to facilitate coupling the patient support 112 to the patient support apparatus 100 in conjunction with the opening 122 and deck 110 in order to restrain movement of the mattress side coupler 630 in at least one direction relative to the patient support apparatus 100. As described herein, the mattress side coupler 630 maybe directly coupled (e.g., a direct mounting via fasteners) or indirectly coupled (e.g., a strap) to the patient support 112.

The mattress side coupler 630 may be similar to the mattress side coupler 530 in many respects for mechanically coupling the patient support 112 to the patient support apparatus 100. The opening 122 and deck 110 in the representative view may operate as a deck side coupler, similar to the deck side coupler 240 without a receiver 244.

In an alternative configuration, the mattress side coupler 630 may be connected to the cable assembly 211 to electrically couple a receiver 244 of a deck side coupler configured accordingly, similar to the mattress side coupler 230 and the deck side coupler 240. The coupling between the mattress side coupler 630 and the deck side coupler in the form of the opening 122 and deck 110 may facilitate maintaining a position of the patient support apparatus 112 on the deck 110 of the patient support apparatus 100.

In one aspect, the present disclosure is not limited to the mattress side coupler 630 being disposed or provided on the patient support 112. The mattress side coupler 630 may be provided anywhere on a mattress. It is further to be understood that the present disclosure is not limited to the patient support 112 being a mattress, and so the mattress side coupler 630 is not limited to use a mattress and may be described as a patient support side coupler 630.

The mattress side coupler 630 may include a base 637, a handle 632, and an engagement body 634, similar respectively to the base 237, the handle 232, and the engagement body 234 of the mattress side coupler 230. The mattress side coupler 630 may include a receiver 638 for a pin to couple with a strap that is connected to the patient support 112.

The detector 660 may include an actuator 663 that is movable in response to movement of the engagement body 634 into engagement with the opening 122 (operable as the deck side coupler without a receiver for electrical contacts). For instance, as the engagement body 634 is received by the opening 122 and engages an edge thereof (e.g., as a deck side coupler), the edge of the opening 122 may operate as a target portion identified as the target 661 and may contact and move the actuator 663 of the detector 660.

The detector 660 in the representative view of FIGS. 22-23 is a mechanical-based detector with an indicator 639 movable between different configurations that identify at least one of 1) presence of the patient support 112 and 2) engagement between the mattress side coupler 630 and the deck side coupler (e.g., the opening 122 and the deck 110). For instance, the actuator 663 may be movable in response to contact with the target 661 (e.g., the edge of the opening 122) to cause mechanical rotation of the actuator 663. The indicator 639 may move in response to such movement of the actuator 663 to identify engagement between the mattress side coupler 630 and the deck side coupler (e.g., the opening 122 and the deck 110). Such movement may be associated with a change in indication relative to a user or caregiver to identify the engagement—e.g., the change in indication may correspond to a color change, such as from red to green with red indicating non-engagement and green indicating engagement. A spring 636 may be provided to bias the actuator 663 toward indicating non-engagement.

It is to be understood the present disclosure is not limited to the mechanical arraignment depicted in FIGS. 20-23, and that any type of mechanical-based and/or electrical-based detector may be utilized for the detector 660.

Directional terms, such as “vertical,” “horizontal,” “top,” “bottom,” “upper,” “lower,” “inner,” “inwardly,” “outer” and “outwardly,” are used to assist in describing embodiments and aspects of the present disclosure based on the orientation of the embodiments and aspects shown in the illustrations. The use of directional terms should not be interpreted to limit embodiments or aspects to any specific orientation(s).

The above description is that of current embodiments and aspects of the disclosure. Various alterations and changes can be made without departing from the spirit and broader aspects of the disclosure as defined in the appended claims, which are to be interpreted in accordance with the principles of patent law including the doctrine of equivalents. This disclosure is presented for illustrative purposes and should not be interpreted as an exhaustive description of all embodiments or aspects of the disclosure or to limit the scope of the claims to the specific elements illustrated or described in connection with these embodiments or aspects. For example, and without limitation, any individual element(s) of the described embodiments or aspects may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments and aspects include a plurality of features that are described in concert and that might cooperatively provide a collection of benefits. The present disclosure is not limited to only those embodiments or aspects that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, and any combination of X, Y and Z, for example, X, Y, Z; X, Y; X, Z; and Y, Z.

While several forms have been shown and described, other changes and modifications will be appreciated by those skilled in the relevant art. Therefore, it will be understood that the embodiments shown in the drawings and described above are merely for illustrative purposes, and are not intended to limit the scope of the disclosure which is defined by the claims which follow as interpreted under the principles of patent law including the doctrine of equivalents.

1-42. (canceled)

43. A patient support coupler for a patient support, the patient support including a deck and a mattress supportable on the deck, the mattress including a head end, a foot end, and two opposed sides, the deck including an opening, the patient support coupler comprising:
a mattress coupler operable to couple the patient support coupler to the mattress; and
a latching mechanism configured to releasably engage the patient support to releasably couple the patient support coupler to the patient support, the latching mechanism including a spring biased catch that releasably engages the patient support, the latching mechanism including a release operable by a user to disengage the spring biased catch from the patient support to facilitate removal of the patient support coupler from the patient support.

44. The patient support coupler of claim 43 comprising an engagement body operable to engage the patient support to facilitate coupling the patient support coupler to the patient support.

45. The patient support coupler of claim 44 wherein the latching mechanism is configured to releasably engage the patient support to releasably couple the patient support coupler to the patient support in cooperation with the engagement body.

46. The patient support coupler of claim 44 wherein the engagement body is operable to engage an edge of the deck. Page

47. The patient support coupler of claim 46 wherein the engagement body is receivable by the opening of the deck, and wherein the edge defines at least a portion of the opening.

48. The patient support coupler of claim 46 wherein the edge corresponds to a perimeter edge of the deck.

49. The patient support coupler of claim 44 wherein the engagement body includes electrical contacts configured to electrically connect with support-side electrical contacts of the patient support for transmission of power and/or data to the engagement body.

50. The patient support coupler of claim 44 wherein the spring biased catch is operable to engage an edge of the opening of the deck to facilitate engagement between the patient support coupler and the deck.

51. The patient support coupler of claim wherein the mattress coupler includes a strap.

52. A patient support for a patient, said patient support comprising:
a deck;
a mattress supportable on the deck, the mattress including a head end, a foot end, and two opposed sides, the mattress including an electrical system configured to at least one of 1) receive power from a power source and 2) include a communication interface for communicating data between the mattress and another device;
a support side coupler operably to facilitate restraining the mattress from moving in at least one direction relative to the deck; and
a mattress side coupler operatively connected to or part of the mattress, the mattress side coupler configured to mechanically couple to the support side coupler to couple the mattress to the support side coupler and facilitate restraining the mattress relative to the deck, the mattress side coupler including a spring biased catch that releasably engages the support side coupler, the mattress side coupler including a release operable by a user to disengage the spring biased catch from the support side coupler to facilitate removal of the mattress side coupler from the support side coupler.

53. The patient support of claim 52 wherein the support side coupler includes a first support side electrical contact, and wherein the mattress side coupler including a first mattress side electrical contact configured to electrically connect to the first support side electrical contact of the support side coupler.

54. The patient support of claim 53 wherein the first support side electrical contact is electrically coupled to a power source and operable to supply power to the electrical system of the mattress via a connection with the first mattress side electrical contact.

55. The patient support of claim 53 wherein:
the support side coupler includes a second support side electrical contact; and
the mattress side coupler includes a second mattress side electrical contact configured to electrically connect to the second support side electrical contact.

56. The patient support of claim 55 wherein the second support side electrical contact is coupled to the other device and operable to transfer communication between the other device and the electrical system via a connection with the second mattress side electrical contact.

57. The patient support of claim 55 wherein the communication interface is configured to at least one of receive and transmit a discrete signal from the other device via the second support side electrical contact and the second mattress side electrical contact.

58. The patient support of claim 53 wherein the support side coupler includes a recess operable to receive an engagement body of the mattress side coupler and to restrain the mattress side coupler from moving laterally and vertically with respect to the deck.

59. The patent support of claim 52 comprising:
the mattress including a patient support surface formed by a plurality of inflatable bladders, the mattress having a recessed portion beneath the patient support surface; and
an enclosure housed in the recessed portion and including the electrical system, the electrical system including a pump for directing air to the plurality of inflatable bladders and a controller for operating the pump.

60. The patient support of claim 52 wherein the mattress side coupler includes an engagement body operable to engage the patient support to facilitate coupling the mattress side coupler to the patient support.

61. The patient support of claim 60 wherein the mattress side coupler is configured to releasably engage the patient support to releasably couple the mattress side coupler to the patient support in cooperation with the engagement body.

62. The patient support of claim 60 wherein the spring biased catch is operable to engage an edge of an opening of the deck to facilitate engagement with the mattress side coupler.
